(19) United States
(12) Patent Application Publication
(10) Pub. No.: US 2025/0095162 A1
(43) Pub. Date: Mar. 20, 2025

(54) LEARNING APPARATUS, COLLATION APPARATUS, LEARNING METHOD, AND COLLATION METHOD

(71) Applicant: NEC Corporation, Minato-ku, Tokyo (JP)

(72) Inventor: Satoshi YAMAZAKI, Tokyo (JP)

(73) Assignee: NEC Corporation, Minato-ku, Tokyo (JP)

(21) Appl. No.: 18/832,545

(22) PCT Filed: Feb. 10, 2022
(86) PCT No.: PCT/JP2022/005440

§ 371 Date: Jul. 24, 2024

(51) Int. Cl. G06T 7/20; G06V 10/44; G06V 10/74; G06V 10/762

(52) U.S. Cl. CPC G06T 7/20; G06V 10/44; G06V 10/761; G06V 10/762; G06T 2207/20081

(57) ABSTRACT

A ground truth weight generation unit generates a ground truth weight for each piece of tracking object data of tracking object information regarding a tracking object by using ground truth tracking object pair information that is a set of tracking object information of the same tracking object or a set of tracking object information of separate tracking objects. An inference model training unit trains, by machine learning, an inference model that outputs a tracking object data weight corresponding to tracking object data included in the tracking object information by using data regarding the tracking object information as input data and using a ground truth weight generated for the tracking object information as ground truth data.

### TECHNICAL FIELD

The present invention relates to a learning apparatus, a collation apparatus, a learning method, a collation method, and a computer readable medium.

### BACKGROUND ART

A method for collating an object such as a person is known. In relation to this technology, Patent Literature 1 discloses a match determination apparatus that efficiently specifies analysis targets same as each other from a plurality of pieces of sensing information. The apparatus according to Patent Literature 1 specifies a selected feature amount selected from one or a plurality of feature amounts for an analysis target included in an analysis group, and evaluates whether analysis targets among a plurality of the analysis groups match based on a combination of selected feature amounts among different analysis groups. In addition, in a case where the evaluation indicates matching of the analysis targets between the analysis groups, the apparatus according to Patent Literature 1 specifies the analysis targets of different analysis groups as the same target.

### CITATION LIST

### Patent Literature

Patent Literature 1: International Patent Publication No. WO2019/138983

### SUMMARY OF INVENTION

### Technical Problem

In the technology according to Patent Literature 1, at the time of collation, it is simply evaluated whether analysis targets among a plurality of analysis groups match each other based on a combination of selected feature amounts among different analysis groups. In such a method, collation may not be performed with high accuracy.

An object of the present disclosure is to solve such a problem, and to provide a learning apparatus, a collation apparatus, a learning method, a collation method, and a program capable of improving collation accuracy.

### Solution to Problem

A learning apparatus according to the present disclosure includes: ground truth weight generation means for generating, for each piece of tracking object data of tracking object information including at least feature amount information indicating a feature of a tracking object that is an object to be tracked and including one or more pieces of tracking object data obtained by tracking the tracking object with a video, a ground truth weight corresponding to ground truth data of a tracking object data weight regarding a degree of importance indicating how well the tracking object data represents the feature of the corresponding tracking object in the tracking object information by using ground truth tracking object pair information that is a set of the tracking object information of the same tracking object or a set of the tracking object information of separate tracking objects; and inference model training means for training, by machine learning, an inference model configured to output a tracking object data weight corresponding to tracking object data included in the tracking object information by using data regarding the tracking object information as input data and using the ground truth weight generated for the tracking object information as ground truth data, wherein the ground truth weight generation means generates the tracking object data weight to be used in association with similarity between tracking object data included in tracking object information regarding a first tracking object of a pair of tracking objects and tracking object data included in tracking object information regarding a second tracking object when calculating a tracking object collation score that is a collation score of the pair of tracking objects in collation processing of the pair of tracking objects.

In addition, a collation apparatus according to the present disclosure includes: weight inference means for inferring a tracking object data weight corresponding to each piece of tracking object data included in tracking object information of each of a pair of tracking objects to be collated by using an inference model trained in advance by machine learning, the inference model being trained to output the tracking object data weight corresponding to tracking object data included in the tracking object information regarding input data by using, as the input data, data regarding tracking object information including at least feature amount information indicating a feature of the tracking object that is an object to be tracked and including one or more pieces of tracking object data obtained by tracking the tracking object with a video and by using a ground truth weight, as ground truth data, corresponding to ground truth data of a tracking object data weight regarding a degree of importance indicating how well the tracking object data indicates a feature of the corresponding tracking object in the tracking object information; and tracking object collation means for performing collation processing of the pair of tracking objects by calculating a tracking object collation score that is a collation score of the pair of tracking objects by associating similarity between tracking object data included in the tracking object information regarding a first tracking object of the pair of tracking objects and tracking object data included in the tracking object information regarding a second tracking object with the inferred tracking object data weight.

In addition, a learning method according to the present disclosure includes: generating, for each piece of tracking object data of tracking object information including at least feature amount information indicating a feature of a tracking object that is an object to be tracked and including one or more pieces of tracking object data obtained by tracking the tracking object with a video, a ground truth weight corresponding to ground truth data of a tracking object data weight regarding a degree of importance indicating how well the tracking object data represents the feature of the corresponding tracking object in the tracking object information by using ground truth tracking object pair information that is a set of the tracking object information of the same tracking object or a set of the tracking object information of separate tracking objects; and training, by machine learning, an inference model configured to output a tracking object data weight corresponding to tracking object data included in the tracking object information by using data regarding the tracking object information as input data and using the ground truth weight generated for the tracking object information as ground truth data, wherein the tracking object data weight is used in association with similarity between tracking object data included in tracking object information regarding a first tracking object of a pair of tracking objects and tracking object data included in tracking object information regarding a second tracking object when calculating a tracking object collation score that is a collation score of the pair of tracking objects in collation processing of the pair of tracking objects.

In addition, a collation method according to the present disclosure includes: inferring a tracking object data weight corresponding to each piece of tracking object data included in tracking object information of each of a pair of tracking objects to be collated by using an inference model trained in advance by machine learning, the inference model being trained to output the tracking object data weight corresponding to tracking object data included in the tracking object information regarding input data by using, as the input data, data regarding tracking object information including at least feature amount information indicating a feature of the tracking object that is an object to be tracked and including one or more pieces of tracking object data obtained by tracking the tracking object with a video and by using a ground truth weight, as ground truth data, corresponding to ground truth data of a tracking object data weight regarding a degree of importance indicating how well the tracking object data indicates a feature of the corresponding tracking object in the tracking object information; and performing collation processing of the pair of tracking objects by calculating a tracking object collation score that is a collation score of the pair of tracking objects by associating similarity between tracking object data included in the tracking object information regarding a first tracking object of the pair of tracking objects and tracking object data included in the tracking object information regarding a second tracking object with the inferred tracking object data weight.

In addition, a first program according to the present disclosure causes a computer to execute the above-described learning method.

In addition, a second program according to the present disclosure causes a computer to execute the above-described collation method.

### Advantageous Effects of Invention

According to the present disclosure, it is possible to provide a learning apparatus, a collation apparatus, a learning method, a collation method, and a program which are capable of improving collation accuracy.

### BRIEF DESCRIPTION OF DRAWINGS

FIG. 1 is a view illustrating an outline of a learning apparatus according to an example embodiment of the present disclosure.

FIG. 2 is a flowchart illustrating a learning method executed by the learning apparatus according to the example embodiment of the present disclosure.

FIG. 3 is a view illustrating an outline of a collation apparatus according to the example embodiment of the present disclosure.

FIG. 4 is a flowchart illustrating a collation method executed by the collation apparatus according to the example embodiment of the present disclosure.

FIG. 5 is a view illustrating a configuration of a collation system according to a first example embodiment.

FIG. 6 is a view illustrating a configuration of a learning apparatus according to the first example embodiment.

FIG. 7 is a view illustrating tracking object information according to the first example embodiment.

FIG. 8 is a view illustrating ground truth tracking object pair information according to the first example embodiment.

FIG. 9 is a view illustrating ground truth tracking object pair information according to the first example embodiment.

FIG. 10 is a flowchart illustrating processing of a ground truth weight generation unit according to the first example embodiment.

FIG. 11 is a view illustrating ground truth tracking object weight information according to the first example embodiment.

FIG. 12 is a diagram for explaining processing of a ground truth weight generation unit according to the first example embodiment.

FIG. 13 is a flowchart illustrating processing of an inference model training unit according to the first example embodiment.

FIG. 14 is a diagram for explaining an inference model training method according to the first example embodiment.

FIG. 15 is a view illustrating a configuration of a collation apparatus according to the first example embodiment.

FIG. 16 is a flowchart illustrating processing of a weight inference unit according to the first example embodiment.

FIG. 17 is a flowchart illustrating processing of a tracking object collation unit according to the first example embodiment.

FIG. 18 is a view illustrating a configuration of a learning apparatus according to a second example embodiment.

FIG. 19 is a flowchart illustrating a learning method executed by the learning apparatus according to the second example embodiment.

FIG. 20 is a flowchart illustrating processing of a tracking object clustering unit according to the second example embodiment.

FIG. 21 is a diagram for explaining processing of the tracking object clustering unit according to the second example embodiment.

FIG. 22 is a diagram illustrating tracking object information stored in a tracking object information storage unit according to the second example embodiment.

FIG. 23 is a view illustrating a state in which the tracking object information stored in the tracking object information storage unit is clustered according to the second example embodiment.

FIG. 24 is a flowchart illustrating processing of a pseudo ground truth tracking object pair information generation unit according to the second example embodiment.

FIG. 25 is a flowchart illustrating processing of the pseudo ground truth tracking object pair information generation unit according to the second example embodiment.

FIG. 26 is a view illustrating pseudo ground truth tracking object pair information corresponding to the same ground truth tracking object pair information according to the second example embodiment.

FIG. 27 is a view illustrating pseudo ground truth tracking object pair information corresponding to separate ground truth tracking object pair information according to the second example embodiment.

### EXAMPLE EMBODIMENT

### Overview of Example Embodiment According to Present Disclosure

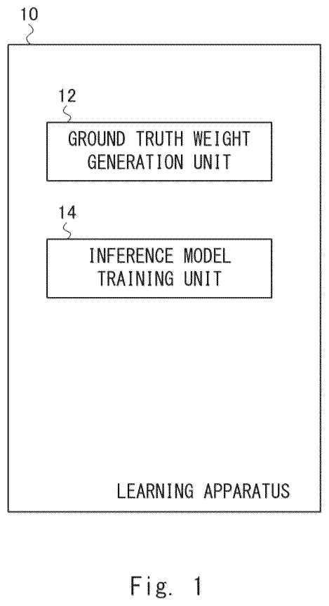

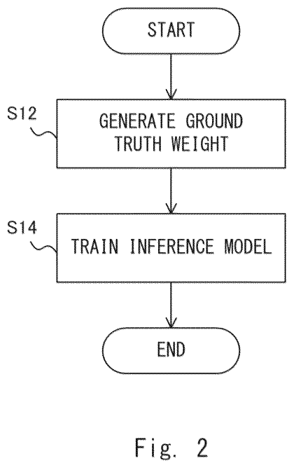

Before an example embodiment of the present disclosure is described, an overview of the example embodiment according to the present disclosure will be described. FIG. 1 is a diagram showing an outline of a learning apparatus 10 according to the example embodiment of the present disclosure. In addition, FIG. 2 is a flowchart illustrating a learning method executed by the learning apparatus 10 according to the example embodiment of the present disclosure.

The learning apparatus 10 is, for example, a computer. The learning apparatus 10 includes a ground truth weight generation unit 12 and an inference model training unit 14. The ground truth weight generation unit 12 has a function as ground truth weight generation means. The inference model training unit 14 has a function as inference model training means. The learning apparatus 10 trains an inference model to be described later.

The ground truth weight generation unit 12 generates a ground truth weight for tracking object information regarding a tracking object that is a tracking target object (object to be tracked) (step S12). The tracking object is, for example, a person, but is not limited thereto. The tracking object may be an animal or a moving object other than a living thing (for example, a vehicle, a flying object, or the like). In the following example embodiments, a case where the tracking object is a person will be assumed and described. Note that, in the following description, “the same tracking object as a tracking object A” represents that in a case where the tracking object is a person, a tracking object is the same person as the tracking object A (person A). Furthermore, “a tracking object separate (different) from a tracking object A” represents that in a case where a tracking object is a person, the tracking object is a person different from the tracking object A (person A). Hereinafter, the tracking object information and the ground truth weight will be described.

The “tracking object information” includes one or more pieces of tracking object data related to a certain tracking object. In other words, the tracking object data included in one piece of tracking object information relates to the same tracking object. For example, when the tracking object is a person, the tracking object information regarding a certain person A (tracking object A) includes one or more pieces of tracking object data on the person A (tracking object A). Note that, in the present example embodiment, it is assumed that a plurality of pieces of tracking object information different from each other exist for a certain person X (tracking object X). The tracking object data includes at least feature amount information indicating a feature of the tracking object. The tracking object data is obtained by tracking a tracking object by a video. The feature amount information may include components (elements) of a plurality of feature amounts. That is, the feature amount information corresponds to a feature amount vector. In addition, the feature amount information is information that makes it possible to calculate similarity between two objects by comparing the feature amount information of the two objects. Details will be described below.

In addition, the “ground truth weight” corresponds to ground truth data (ground truth label) used in a training stage of an inference model to be described later. In addition, the ground truth weight corresponds to ground truth data of a tracking object data weight which is a weight related to the tracking object data.

The “tracking object data weight” is associated with each piece of tracking object data included in the tracking object information. The tracking object data weight relates to the degree of importance indicating how well the corresponding object data represents a feature of the corresponding tracking object in the tracking object information including tracking object data. In other words, the tracking data weight may correspond to a relative degree importance of one or more pieces of tracking object data included in the tracking object information, in the tracking object information when collation is performed between two pieces of tracking object information. The ground truth weight and the tracking object data weight will be described later. Note that, the “tracking object data weight” corresponds to output data of an inference model as described later. In other words, the tracking object data weight is inferred by the inference model to be described later. That is, the inference model to be described later outputs the tracking object data weight corresponding to the tracking object data included in the tracking object information.

Here, the tracking object data weight is used when calculating a tracking object collation score corresponding to a collation score (degree of matching, similarity, or the like) of a pair of tracking objects in a collation process of the pair of tracking objects. Specifically, the tracking object data weight is used in association with the similarity between tracking object data included in tracking object information regarding a first tracking object of the pair of tracking objects and tracking object data included in tracking object information regarding a second tracking object of the pair of tracking objects. A specific method of calculating the tracking object collation score will be described later.

In addition, the ground truth weight generation unit 12 generates the ground truth weight by using ground truth tracking object pair information. The “ground truth tracking object pair information” is information in which two pieces of tracking object information are paired. The ground truth tracking object pair information is a set of tracking object information of tracking objects same as each other (i.e., “same tracking object”) or a set of tracking object information of tracking objects different from each other (i.e., “different tracking objects”). The ground truth tracking object pair information will be described later. Further, details of a process of S12 will be described later.

The inference model training unit 14 trains the inference model by machine learning such as a neural network (step S14). The inference model training unit 14 trains an inference model that outputs a tracking object data weight corresponding to tracking object data included in the tracking object information by using data regarding the tracking object information as input data and using a ground truth weight generated for the tracking object information as ground truth data. Note that, input data (feature) of the inference model will be described later. Further, details of the process of S14 will be described later.

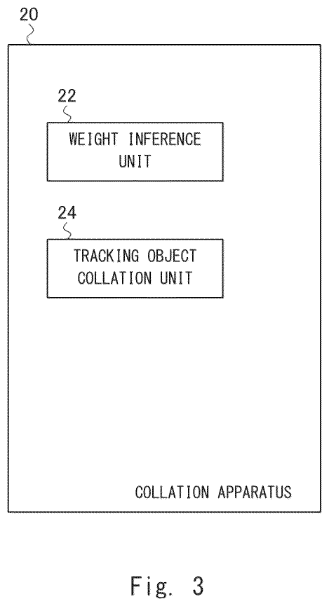

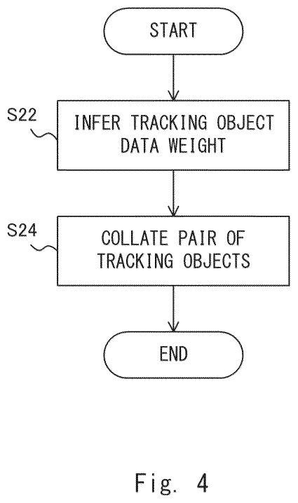

FIG. 3 is a view illustrating an outline of a collation apparatus 20 according to the example embodiment of the present disclosure. In addition, FIG. 4 is a flowchart illustrating a collation method executed by the collation apparatus 20 according to the example embodiment of the present disclosure.

The collation apparatus 20 is, for example, a computer. The collation apparatus 20 includes a weight inference unit 22 and a tracking object collation unit 24. The weight inference unit 22 has a function as weight inference means (inference means). The tracking object collation unit 24 has a function as tracking object collation means (collation means). The collation apparatus 20 collates a tracking object by using a trained inference model.

The weight inference unit 22 infers a tracking object data weight by using the inference model trained in advance by machine learning as described above (step S22). Specifically, the weight inference unit 22 infers the tracking object data weight corresponding to each piece of tracking object data included in the tracking object information of each of the pair of tracking objects to be collated by using the inference model trained as described above.

The tracking object collation unit 24 performs a collation process for the pair of tracking objects to be collated (step S24). Here, the pair of tracking objects includes a first tracking object and a second tracking object. Then, the tracking object collation unit 24 calculates a tracking object collation score of the pair of tracking objects by associating the similarity between tracking object data included in tracking object information of a first tracking object and tracking object data included in tracking object information of a second tracking object with inferred tracking object data weight that is inferred. According to this, the tracking object collation unit 24 performs a collation process for the pair of tracking objects.

Here, an example of a method of calculating the tracking object collation score according to the present example embodiment will be described. In the present example embodiment, for example, the tracking object collation score is calculated as shown in the following Expression (1). Expression (1) is an expression for calculating a collation score (tracking object collation score) between a tracking object A and a tracking object B.

$$\begin{matrix}[ Mathematical Expression 1 ] & \\ Score = {\sum }_{i = 1}^{n} {\sum }_{j = 1}^{m} {w}_{i}^{A} {w}_{j}^{B} {f}_{i , j} & ( 1 )\end{matrix}$$

In Expression (1), “Score” is a tracking object collation score between the tracking object A and the tracking object B. The higher the Score, the higher the possibility that the tracking object A and the tracking object B are the same tracking object. In addition, n is the number of pieces of tracking object data in the tracking object information of the tracking object A. m is the number of pieces of tracking object data in the tracking object information of the tracking object B. In addition, i is an index of the tracking object data in the tracking object information of the tracking object A. j is an index of the tracking object data in the tracking object information of the tracking object B. In addition, wᵢ^{A} is a tracking object data weight corresponding to the tracking object data i in the tracking object information of the tracking object A. In addition, wⱼ^{B} is a tracking object data weight corresponding to the tracking object data j in the tracking object information of the tracking object B. In addition, f_{i,j} represents similarity between the tracking object data i in the tracking object information of the tracking object A and the tracking object data j in the tracking object information of the tracking object B. f_{i,j} may represent, for example, cosine similarity of feature amount information (feature amount vector) included in the tracking object data.

As shown in Expression (1), the tracking object collation score corresponds to the sum of products of similarity between the tracking object data and weights of the two pieces of tracking object data for each of all combinations of the tracking object data in the tracking object information of the tracking object A and the tracking object data in the tracking object information of the tracking object B. That is, the tracking object collation score corresponds to a value obtained by adding the product of similarity between the tracking object data in the tracking object information of the tracking object A and the tracking object data in the tracking object information of the tracking object B, and the weight of the two pieces of tracking object data for all combinations of the tracking object data. In addition, the tracking object collation score, the weight w, and the similarity f_{i,j} can take values in a range of (0,1).

Here, for comparison with the present example embodiment, a method of calculating the tracking object collation score according to a comparative example will be described below. In the comparative example, the tracking object collation score is calculated as indicated by the following Expression (2). Expression (2) is an expression for calculating a collation score (tracking object collation score) between the tracking object A and the tracking object B.

$$\begin{matrix}[ Mathematical Expression 2 ] & \\ Score = \frac{1}{nm} {\sum }_{i = 1}^{n} {\sum }_{j = 1}^{m} {f}_{i , j} & ( 2 )\end{matrix}$$

As shown in Expression (2), in the comparative example, the tracking object collation score is calculated by an average of similarity between tracking object data for each of all combinations of the tracking object data in the tracking object information of the tracking object A and the tracking object data in the tracking object information of the tracking object B. In the tracking object collation score calculated in this manner, the weights of all of the tracking object data are treated as being equivalent. That is, in the tracking object collation score calculated by the method according to the comparative example, the weight of the tracking object data is not considered. Here, the tracking object data included in the tracking object information may well represent the feature of the corresponding tracking object or may not well represent the feature of the tracking object. Therefore, the degree of importance (the degree of contribution) of the tracking object data included in the tracking object information is not constant. Therefore, there is a possibility that collation accuracy is not satisfactory with the tracking object collation score calculated by equally treating the tracking object data.

Contrary to this, the tracking object collation score according to the present example embodiment corresponds to the sum of products of the similarity for each of all combinations of the tracking object data in the tracking object information of the tracking object A and the tracking object data in the tracking object information of the tracking object B, and the corresponding weights of the two pieces of tracking object data. In other words, the tracking object collation score according to the present example embodiment corresponds to a weighted average of the similarity for each of all combinations of the tracking object data in the tracking object information of the tracking object A and the tracking object data in the tracking object information of the tracking object B. Therefore, when calculating the tracking object collation score, the tracking object data weight is used in association with the similarity between the tracking object data included in the tracking object information regarding the first tracking object of the pair of tracking objects and the tracking object data included in the tracking object information regarding the second tracking object. As a result, the weight of the tracking object data is added to the similarity between the two pieces of tracking object data. Therefore, in the tracking object collation score, the similarity relating to the tracking object data that is important in the tracking object information (well representing the feature of the tracking object) is regarded as being important. As a result, the accuracy of the tracking object collation score can be increased.

Therefore, the collation apparatus 20 according to the present example embodiment can perform collation with high accuracy. Furthermore, the learning apparatus 10 according to the present example embodiment can train an inference model for inferring the tracking object data weight necessary for accurately performing collation. Then, the learning apparatus 10 according to the present example embodiment can generate ground truth data corresponding to the ground truth data of the tracking object data weight which is used in the training of the inference model. Therefore, the learning apparatus 10 according to the present example embodiment can improve the accuracy of collation. Note that, the accuracy of collation can also be improved by a learning method for realizing the learning apparatus 10 and the program for executing the learning method. In addition, the collation method for realizing the collation apparatus 20 and the program for executing the collation method also enable accurate collation.

Furthermore, the ground truth weight generation unit 12 may generate the ground truth weight based on the similarity between each piece of the tracking object data included in the tracking object information of one tracking object and each piece of the tracking object data included in the tracking object information of the other tracking object in each of a plurality of pieces of ground truth tracking object pair information (S12). As a result, it is possible to more effectively generate the ground truth weight. Details will be described below.

### First Example Embodiment

Hereinafter, an example embodiment will be described with reference to the drawings. To clarify description, in the following description and drawings, omission and simplification are made as appropriate. In each drawing, the same elements are denoted by the same reference signs, and redundant description will be omitted as necessary.

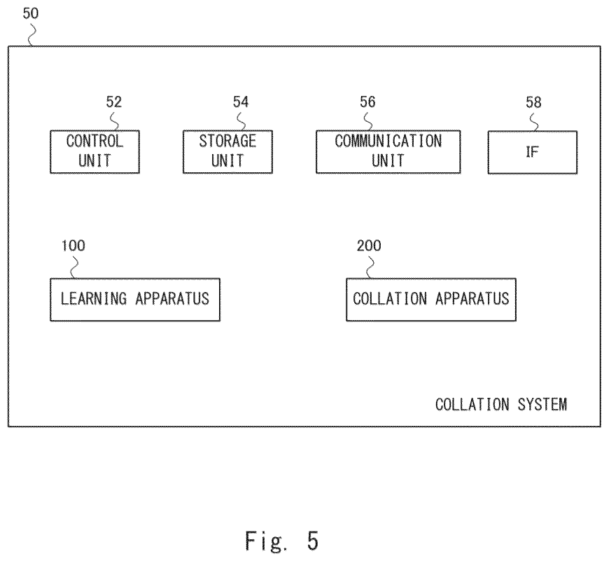

FIG. 5 is a view illustrating a configuration of a collation system 50 according to the first example embodiment. The collation system 50 includes a control unit 52, a storage unit 54, a communication unit 56, and an interface unit 58 (interface (IF)) as main hardware configurations. The control unit 52, the storage unit 54, the communication unit 56, and the interface unit 58 are connected to each other via a data bus or the like.

The control unit 52 is, for example, a processor such as a central processing unit (CPU). The control unit 52 has a function as an arithmetic operation apparatus that performs a control process, an arithmetic operation process, and the like. The control unit 52 may include a plurality of processors. The storage unit 54 is, for example, a storage device such as a memory or a hard disk. The storage unit 54 is, for example, read only memory (ROM), random access memory (RAM), or the like. The storage unit 54 has a function of storing a control program, an arithmetic operation program, and the like executed by the control unit 52. That is, the storage unit 54 (memory) stores one or more instructions. The storage unit 54 has a function of temporarily storing processing data and the like. The storage unit 54 may include a database. The storage unit 54 may include a plurality of memories.

The communication unit 56 performs processing necessary for performing communication with another apparatus via a network. The communication unit 56 may include a communication port, a router, a firewall, and the like. The interface unit 58 (interface (IF)) is, for example, a user interface (UI). The interface unit 58 includes an input apparatus such as a keyboard, a touch panel, or a mouse, and an output apparatus such as a display or a speaker. The interface unit 58 may be configured such that the input apparatus and the output apparatus are integrated, for example, like a touch screen (touch panel). The interface unit 58 receives a data inputting operation by a user (operator) and outputs information to the user. The interface unit 58 may display a collation result.

In addition, the collation system 50 includes a learning apparatus 100 and a collation apparatus 200. The learning apparatus 100 corresponds to the learning apparatus 10 described above. The collation apparatus 200 corresponds to the collation apparatus 20 described above. The learning apparatus 100 and the collation apparatus 200 are, for example, computers. The learning apparatus 100 and the collation apparatus 200 may be realized by physically the same apparatus. Alternatively, the learning apparatus 100 and the collation apparatus 200 may be realized by physically separate apparatuses (computers). In this case, each of the learning apparatus 100 and the collation apparatus 200 has the above-described hardware configuration.

The learning apparatus 100 executes the learning method illustrated in FIG. 2. That is, the learning apparatus 100 generates the ground truth weight and trains the inference model used in the collation of the tracking object. The collation apparatus 200 executes the collation method illustrated in FIG. 4. That is, the collation apparatus 200 uses a trained inference model to infer the weight (tracking object data weight) of the tracking object data included in the tracking object information regarding each of a pair of tracking objects to be collated, and calculates a collation score by using the obtained tracking object data weight. Details of the learning apparatus 100 and the collation apparatus 200 will be described later.

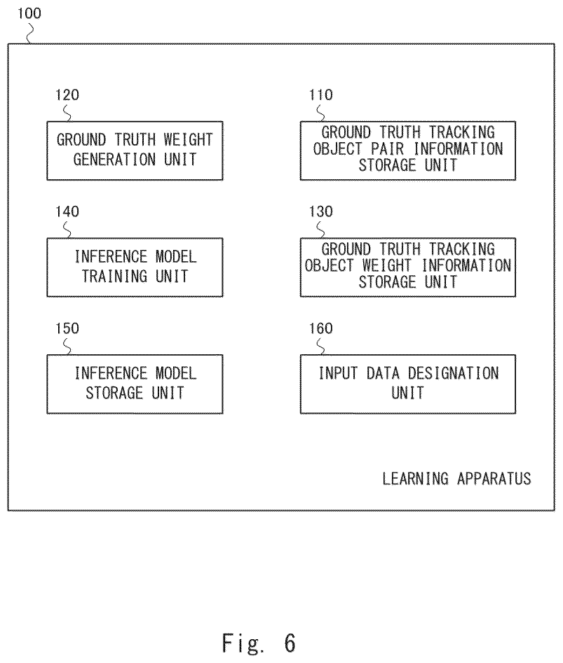

FIG. 6 is a view illustrating a configuration of the learning apparatus 100 according to the first example embodiment. The learning apparatus 100 may include the control unit 52, the storage unit 54, the communication unit 56, and the interface unit 58 illustrated in FIG. 5 as a hardware configuration. In addition, the learning apparatus 100 includes, as constituent elements, a ground truth tracking object pair information storage unit 110, a ground truth weight generation unit 120, a ground truth tracking object weight information storage unit 130, an inference model training unit 140, an inference model storage unit 150, and an input data designation unit 160. Note that, the learning apparatus 100 does not need to be configured by physically one apparatus. In this case, each of the above-described constituent elements may be realized by a plurality of physically separate apparatuses.

The ground truth tracking object pair information storage unit 110 has a function as ground truth tracking object pair information storage means (information storage means). The ground truth weight generation unit 120 corresponds to the ground truth weight generation unit 12 illustrated in FIG. 1. The ground truth weight generation unit 120 has a function as ground truth weight generation means. The ground truth tracking object weight information storage unit 130 has a function as ground truth tracking object weight information storage means (information storage means). The inference model training unit 140 corresponds to the inference model training unit 14 illustrated in FIG. 1. The inference model training unit 140 has a function as inference model training means. The inference model storage unit 150 has a function as inference model storage means. The input data designation unit 160 has a function as input data designation means (designation means).

Each of the above-described constituent elements can be realized, for example, by executing a program under the control of the control unit 52. More specifically, each constituent element can be realized by causing the control unit 52 to execute a program (command) stored in the storage unit 54. Each constituent element may be realized by recording a necessary program in any nonvolatile recording medium and installing the program as necessary. Each constituent element is not limited to be realized by software by a program, and may be realized by any combination of hardware, firmware, and software. Each constituent element may be realized using an integrated circuit such as a field-programmable gate array (FPGA) or a microcomputer that can be programmed by a user. In this case, an integrated circuit may be used to realize a program including the above-described constituent elements. The same is true of the collation apparatus 200 and other example embodiments described later.

The ground truth tracking object pair information storage unit 110 stores a plurality of pieces of ground truth tracking object pair information. For example, the ground truth tracking object pair information storage unit 110 may store approximately 100 to 1000 pieces of ground truth tracking object pair information. As described above, the ground truth tracking object pair information is information in which two pieces of tracking object information are paired. Therefore, the ground truth tracking object pair information includes a pair of tracking object information.

The ground truth tracking object pair information is the same ground truth tracking object pair information or separate ground truth tracking object pair information. The same ground truth tracking object pair information is a set of tracking object information of the same tracking object. On the other hand, the separate ground truth tracking object pair information is a set of tracking object information of separate tracking objects. Therefore, in the ground truth tracking object pair information, it is clear in advance whether two pieces of tracking object information are tracking object information regarding the same tracking object or the two pieces of tracking object information are tracking object information regarding different tracking objects. That is, the same ground truth tracking object pair information is generated by using reliably (accurately) the tracking object information regarding the same tracking object. Further, the separate ground truth tracking object pair information is generated by using the tracking object information regarding reliably (accurately) the separate tracking objects.

Here, a specific example of the tracking object information and the ground truth tracking object pair information will be described with reference to the drawings.

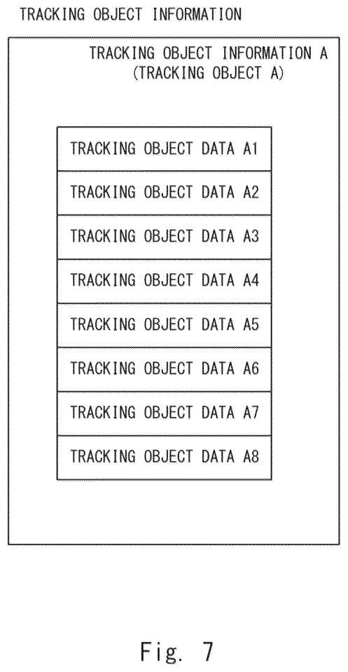

FIG. 7 is a view illustrating tracking object information according to the first example embodiment. FIG. 7 illustrates the tracking object information (tracking object information A) related to a certain tracking object A (for example, a person A). The tracking object information illustrated in FIG. 7 includes eight pieces of tracking object data A1 to A8.

The tracking object data can be acquired, for example, from an image (video) obtained by an imaging device such as a camera with respect to a certain tracking object. Each of a plurality of pieces of tracking object data included in one piece of tracking object information can correspond to, for example, each of different frames (moving image frames) in a video (moving image). The frame corresponds to each still image (frame) constituting video data. Each of the plurality of pieces of tracking object data included in one piece of tracking object information can be acquired by performing object detection processing (image processing) on each of different frames. Note that, the plurality of pieces of tracking object data included in one piece of tracking object information may correspond to frames of videos obtained by different imaging devices, respectively.

In addition, as described above, the tracking object information includes one or more tracking object data related to the same tracking object. Here, the tracking object information can include tracking object data of different frames related to the same tracking object by the object tracking processing. That is, the tracking object information can be acquired, for example, by object tracking processing (video analysis processing) using an image sequence (video) obtained by an imaging device such as a camera as an input. The object tracking processing may be, for example, processing of detecting and tracking the same object as an object detected in an image frame at a certain time in a subsequent time frame by using an image sequence of the object in a time-series order as an input. Note that, in the object tracking processing, for example, the same object can be tracked based on similarity in position and appearance of the object in the image.

In addition, as described above, the tracking object data includes at least feature amount information indicating a feature of the tracking object. The feature amount information can be acquired, for example, by performing object detection processing on a frame, detecting a tracking object present in the frame, extracting image data of the detected tracking object, and acquiring a feature amount of the tracking object from the extracted image data. As a method of acquiring the feature amount of the tracking object from the image data of the tracking object, an existing algorithm may be used. For example, the feature amount of the tracking object may be acquired by using a trained model trained by machine learning such as a neural network so as to output the feature amount of the object indicated by the image using the image data as an input. Examples of components (elements) of the feature amount indicated by the feature amount information include, but are not limited to, a position of a feature point of a face of a person, the degree of human-likeness, a coordinate position of a skeleton point, and the reliability of a clothing label.

As described above, the tracking object data A1 to A8 may be acquired from different frames. Each of the tracking object data A1 to A8 includes at least feature amount information corresponding to the tracking object A. Furthermore, the tracking object data may indicate time when the corresponding frame has been obtained and a position and a size of the tracking object in the corresponding frame (image). The position and size of the tracking object may be position coordinates and a size of a rectangle surrounding the tracking object in the frame. Note that, the components (elements) of the feature amount indicated by the feature amount information included in each of the tracking object data A1 to A8 may be the same as each other, but values (component values) of the respective components may be different from each other.

Note that, the number of pieces of tracking object data included in one piece of tracking object information is not limited to eight, and may be any number. Furthermore, mutually different tracking objects information may include a different number of tracking object data. For example, one piece of tracking object information may include eight pieces of tracking object data, another piece of tracking object information may include six pieces of tracking object data, and still another piece of tracking object information may include one piece of tracking object data.

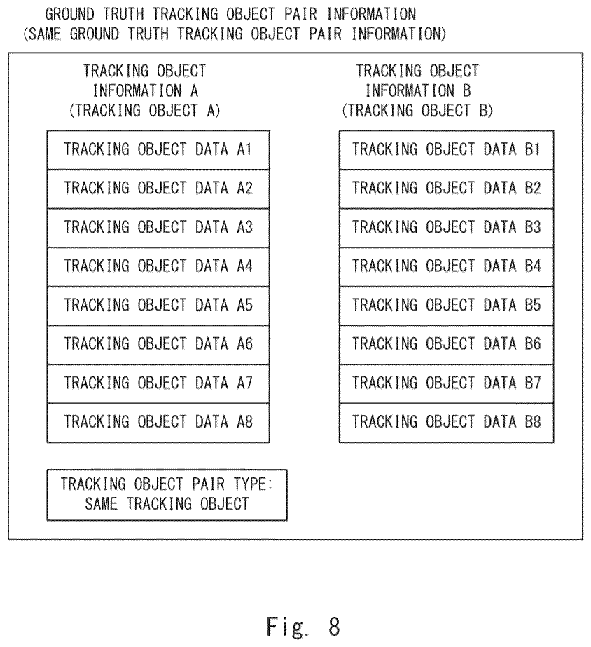

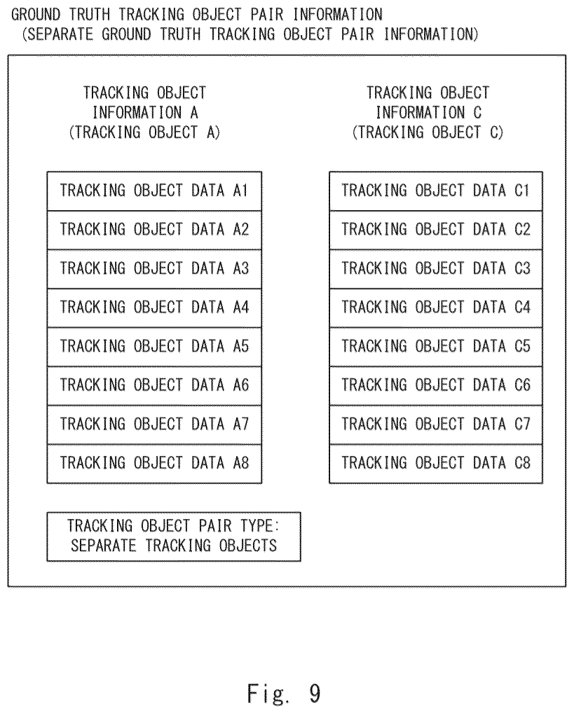

FIG. 8 and FIG. 9 are views illustrating ground truth tracking object pair information according to the first example embodiment. FIG. 8 is a view illustrating the same ground truth tracking object pair information. FIG. 9 is a view illustrating separate ground truth tracking object pair information.

The ground truth tracking object pair information (the same ground truth tracking object pair information) illustrated in FIG. 8 includes tracking object information regarding each of the tracking object A and the tracking object B which are the same tracking object. That is, the tracking object A and the tracking object B are, for example, the same person X. The tracking object information (tracking object information A) related to the tracking object A includes eight pieces of tracking object data A1 to A8. The tracking object information (tracking object information B) related to the tracking object B includes eight pieces of tracking object data B1 to B8.

For example, the tracking object information A and the tracking object information B may be obtained from images captured in different time zones. For example, the tracking object information A may include tracking object data acquired from a video obtained by imaging the person X from 11:00. In addition, the tracking object information B may include tracking object data acquired from a video obtained by imaging the person X from 13:00. Alternatively, the tracking object information A and the tracking object information B may be obtained from, for example, images captured by imaging devices provided at different positions. For example, the tracking object information A may include tracking object data acquired from a video obtained by imaging the person X from a left side or a forward side. In addition, the tracking object information B may include tracking object data acquired from a video obtained by imaging the person X from a right side or a rearward side.

In addition, the ground truth tracking object pair information includes a tracking object pair type. The tracking object pair type indicates whether the pair of tracking object information included in the ground truth tracking object pair information is the tracking object information regarding the same tracking object or the tracking object information regarding different tracking objects. The tracking object pair type included in the ground truth tracking object pair information (the same ground truth tracking object pair information) illustrated in FIG. 8 indicates “the same tracking object”. That is, the same ground truth tracking object pair information illustrated in FIG. 8 is generated by using the tracking object information regarding the tracking object A and tracking object B which are the same as each other with certainty.

The ground truth tracking object pair information (separate ground truth tracking object pair information) illustrated in FIG. 9 includes tracking object information regarding each of the tracking object A and the tracking object C which are different tracking objects. For example, the tracking object A is the person X, and the tracking object C is a person Y different from the person X. The tracking object information (tracking object information A) related to the tracking object A includes eight pieces of tracking object data A1 to A8. The tracking object information (tracking object information C) related to the tracking object C includes eight pieces of tracking object data C1 to C8. In addition, the tracking object pair type included in the ground truth tracking object pair information (separate ground truth tracking object pair information) illustrated in FIG. 9 indicates “different tracking objects”. That is, the separate ground truth tracking object pair information illustrated in FIG. 9 is generated by using the tracking object information regarding the tracking object A and tracking object C which are different from each other with certainty.

Here, the tracking object information A included in the ground truth tracking object pair information (separate ground truth tracking object pair information) illustrated in FIG. 9 is the same as the tracking object information A included in the ground truth tracking object pair information (same ground truth tracking object pair information) illustrated in FIG. 8. That is, the same tracking object information regarding a certain tracking object may be included in each of the plurality of ground truth tracking object pair information. Therefore, the tracking object information A may be included in the same ground truth tracking object pair information different from the same ground truth tracking object pair information illustrated in FIG. 8. Similarly, the tracking object information A may be included in separate ground truth tracking object pair information different from the separate ground truth tracking object pair information illustrated in FIG. 9.

Note that, the number of pieces of tracking object data included in each piece of tracking object information included in the ground truth tracking object pair information is in any number of pieces of tracking object data. For example, in the example of FIG. 8, the tracking object information A may include six pieces of tracking object data, and the tracking object information B may include four pieces of tracking object data. In addition, in the example of FIG. 9, the tracking object information A may include six pieces of tracking object data, and the tracking object information C may include one piece of tracking object data. However, at least one of the tracking object information included in the ground truth tracking object pair information needs to include a plurality of pieces of tracking object data.

The ground truth weight generation unit 120 generates a ground truth weight by using the ground truth tracking object pair information. Specifically, the ground truth weight generation unit 120 may calculate the similarity between each of the tracking object data included in the tracking object information of one tracking object and each of the tracking object data included in the tracking object information of the other tracking object in each of the plurality of pieces of ground truth tracking object pair information. Then, the ground truth weight generation unit 120 may generate a ground truth weight related to the tracking object data based on the calculated similarity.

Furthermore, the ground truth weight generation unit 120 may assign (i.e., add) a point (weight point) to the tracking object data based on the calculated similarity, and generate ground truth weights regarding the tracking object data according to the number of added points. Furthermore, the ground truth weight generation unit 120 may add a point to the tracking object data corresponding to the highest similarity among similarities calculated by using a set of tracking object information of the same tracking object (same ground truth tracking object pair information) among a plurality of pieces of the ground truth tracking object pair information. Furthermore, the ground truth weight generation unit 120 may add a point to the tracking object data corresponding to the lowest similarity among similarities calculated by using a set of tracking object information of different tracking objects (separate ground truth tracking object pair information) among a plurality of pieces of the ground truth tracking object pair information.

Hereinafter, processing of the ground truth weight generation unit 120 will be described in detail with reference to a flowchart.

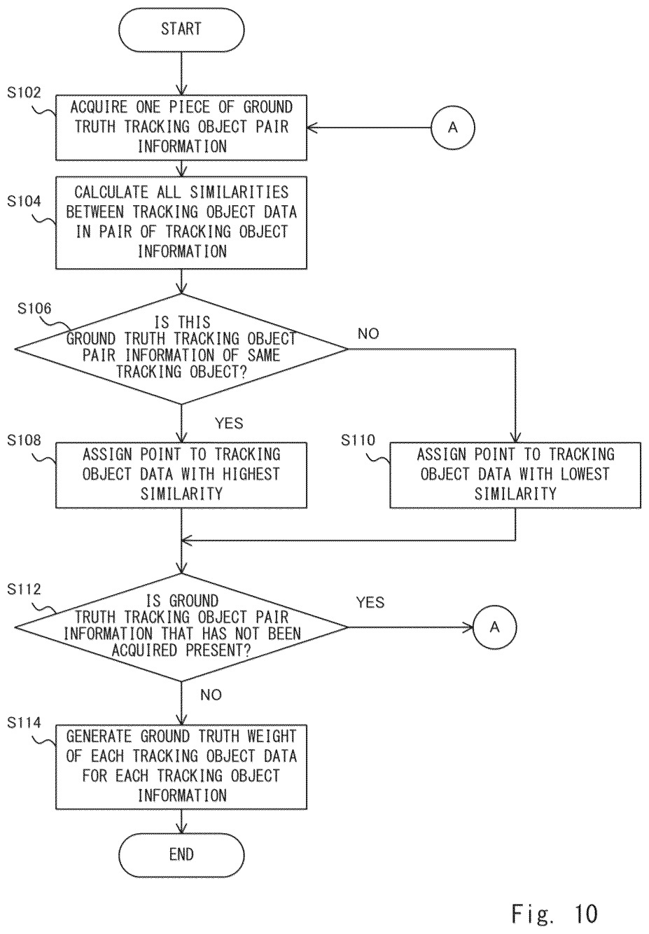

FIG. 10 is a flowchart illustrating processing of a ground truth weight generation unit 120 according to the first example embodiment. The processing of the flowchart illustrated in FIG. 10 corresponds to the processing in S12 illustrated in FIG. 2. The ground truth weight generation unit 120 acquires one piece of ground truth tracking object pair information from the ground truth tracking object pair information storage unit 110 (step S102). As a result, a pair of tracking object information is acquired.

The ground truth weight generation unit 120 calculates all similarities between the tracking object data in the pair of tracking object information included in the acquired ground truth tracking object pair information (step S104). Here, the “similarity between the tracking object data” may be f_{i,j} illustrated in Expression (1). Specifically, the ground truth weight generation unit 120 calculates the similarity for all combinations of each of the tracking object data included in one piece of tracking object information and each of the tracking object data included in the other piece of tracking object information in the acquired ground truth tracking object pair information.

In a case where the ground truth tracking object pair information illustrated in FIG. 8 is acquired, the ground truth weight generation unit 120 calculates similarity between the tracking object data A1 and the tracking object data B1. In addition, the ground truth weight generation unit 120 calculates similarity between the tracking object data A1 and the tracking object data B2. Similarly, the ground truth weight generation unit 120 calculates similarity between the tracking object data A1 and each of the tracking object data B1 to B8. In addition, the ground truth weight generation unit 120 similarly calculates similarity between the tracking object data A2 and each of the tracking object data B1 to B8. Similarly, the ground truth weight generation unit 120 calculates similarity between the tracking object data for all combinations of each of the tracking object data A1 to A8 and each of the tracking object data B1 to B8. That is, the ground truth weight generation unit 120 calculates the similarity between the tracking object data for all of 64 (=8×8) combinations of each of 8 pieces of tracking object data of the tracking object information A and each of 8 tracking object data of the tracking object information B.

In a case where the ground truth tracking object pair information illustrated in FIG. 9 is acquired, the ground truth weight generation unit 120 calculates similarity between the tracking object data A1 and the tracking object data C1. In addition, the ground truth weight generation unit 120 calculates similarity between the tracking object data A1 and the tracking object data C2. Similarly, the ground truth weight generation unit 120 calculates similarity between the tracking object data A1 and each of the tracking object data C1 to C8. In addition, the ground truth weight generation unit 120 similarly calculates similarity between the tracking object data A2 and each of the tracking object data C1 to C8. Similarly, the ground truth weight generation unit 120 calculates similarity between the tracking object data for all combinations of each of the tracking object data A1 to A8 and each of the tracking object data C1 to C8. That is, the ground truth weight generation unit 120 calculates the similarity between the tracking object data for all of 64 (=8×8) combinations of each of 8 pieces of tracking object data of the tracking object information A and each of 8 tracking object data of the tracking object information C.

The ground truth weight generation unit 120 determines whether or not the acquired ground truth tracking object pair information includes tracking object information of the same tracking object (step S106). Specifically, the ground truth weight generation unit 120 determines whether or not the tracking object pair type of the acquired ground truth tracking object pair information indicates “the same tracking object”. In a case where the tracking object pair type of the acquired ground truth tracking object pair information indicates “the same tracking object”, the ground truth weight generation unit 120 determines that the acquired ground truth tracking object pair information includes the tracking object information of the same tracking object. On the other hand, in a case where the tracking object pair type of the acquired ground truth tracking object pair information indicates “different tracking objects”, the ground truth weight generation unit 120 determines that the acquired ground truth tracking object pair information includes the tracking object information of different tracking objects.

When the ground truth tracking object pair information includes the tracking object information of the same tracking object (YES in S106), the ground truth weight generation unit 120 assigns a point to the tracking object data having the highest similarity (step S108). Specifically, the ground truth weight generation unit 120 assigns a point (weight point) to each of two pieces of (one set of) tracking object data used when the highest similarity among calculated similarities is calculated.

For example, in the example of FIG. 8, it is assumed that the similarity between the tracking object data A2 and the tracking object data B7 is the highest among 64 similarities calculated in the processing in S104. In this case, the ground truth weight generation unit 120 assigns a weight point “1” to each of the tracking object data A2 and the tracking object data B7.

In a case where the tracking object pair type of the ground truth tracking object pair information is “the same tracking object”, it is desirable that one piece of tracking object information and the other piece of tracking object information are similar to each other. Therefore, it is desirable that a tracking object collation score between one piece of tracking object information and the other piece of tracking object information is high. Then, from Expression (1) or Expression (2) described above, the tracking object collation score may be higher as the similarity between each piece of the tracking object data of one piece of the tracking object information and the tracking object data of the other piece of the tracking object information is higher. Therefore, it can be said that two pieces of tracking object data constituting a combination with high similarity among combinations of each piece of tracking object data of one piece of tracking object information and the tracking object data of the other piece of tracking object information satisfactorily represent the feature of the corresponding tracking object in the tracking object information to which the two pieces of tracking object data belong. Therefore, in a case where the tracking object pair type of the ground truth tracking object pair information is “the same tracking object”, the ground truth weight generation unit 120 assigns a weight point to each of the two tracking object data constituting the combination corresponding to the highest similarity among all combinations. As a result, it is possible to assign a weight point to the tracking object data with a high degree of importance.

On the other hand, in a case where the ground truth tracking object pair information includes tracking object information of separate tracking objects (NO in S106), the ground truth weight generation unit 120 assigns a point to the tracking object data with the lowest similarity (step S110). Specifically, the ground truth weight generation unit 120 assigns a point (weight point) to each of two pieces of (one set of) tracking object data used when the lowest similarity among calculated similarities is calculated.

For example, in the example of FIG. 9, it is assumed that the similarity between the tracking object data A6 and the tracking object data C8 is the lowest among the 64 similarities calculated in the processing in S104. In this case, the ground truth weight generation unit 120 assigns a weight point “1” to each of the tracking object data A6 and the tracking object data C8.

In a case where the tracking object pair type of the ground truth tracking object pair information is “separate tracking object”, it is desirable that one piece of tracking object information and the other piece of tracking object information are different (not similar) from each other. Therefore, it is desirable that a collation score between one piece of tracking object information and the other piece of tracking object information is low. Then, from Expression (1) or Expression (2) described above, the collation score may be lower as the similarity between each piece of the tracking object data of one piece of the tracking object information and the tracking object data of the other piece of the tracking object information is lower. Therefore, it can be said that two pieces of tracking object data constituting a combination with low similarity among combinations of each piece of tracking object data of one piece of tracking object information and the tracking object data of the other piece of tracking object information satisfactorily represent the feature of the corresponding tracking object in the tracking object information to which the two pieces of tracking object data belong. Therefore, in a case where the tracking object pair type of the ground truth tracking object pair information is “separate tracking object”, the ground truth weight generation unit 120 assigns a weight point to each of the two tracking object data constituting the combination corresponding to the lowest similarity among all combinations. As a result, it is possible to assign a weight point to the tracking object data with a high degree of importance.

The ground truth weight generation unit 120 determines whether or not there is ground truth tracking object pair information that has not been acquired from the ground truth tracking object pair information storage unit 110 (step S112). If there is ground truth tracking object pair information that has not been acquired (YES in S112), the processing flow returns to S102. Then, the processing in S102 to S112 is repeated. As a result, for each of a plurality of pieces of ground truth tracking object pair information stored in the ground truth tracking object pair information storage unit 110, a weight point is assigned to each tracking object data of the tracking object information included in the ground truth tracking object pair information. Here, as described above, the same tracking object information (for example, the tracking object information A) related to a certain tracking object may be included in each of the plurality of pieces of ground truth tracking object pair information. Therefore, by repeating the processing in S102 to S112, the weight point related to each tracking object data of each tracking object information is added.

On the other hand, when there is no ground truth tracking object pair information that has not been acquired (NO in S112), the ground truth weight generation unit 120 generates the ground truth weight of each tracking object data for each tracking object information (step S114). Specifically, the ground truth weight generation unit 120 calculates a total value of the assigned weight points for each tracking object data included in the tracking object information. In the tracking object information, the ground truth weight generation unit 120 normalizes the total value of the weight points calculated for each tracking object data in a range of 0 to 1 to generate the ground truth weight for each tracking object data. Specifically, the ground truth weight generation unit 120 generates a ground truth weight for each tracking object data by dividing the total value of the weight points of each tracking object data by the sum of the total values of the weight points calculated for each tracking object data in the tracking object information. As a result, the sum of the ground truth weight regarding the tracking object data in the tracking object information is 1. The ground truth weight generation unit 120 generates ground truth tracking object weight information corresponding to the tracking object information.

The ground truth tracking object weight information storage unit 130 stores ground truth tracking object weight information corresponding to each tracking object information. The ground truth tracking object weight information storage unit 130 stores the ground truth tracking object weight information corresponding to each of the plurality of pieces of tracking object information included in the plurality of pieces of ground truth tracking object pair information stored in the ground truth tracking object pair information storage unit 110.

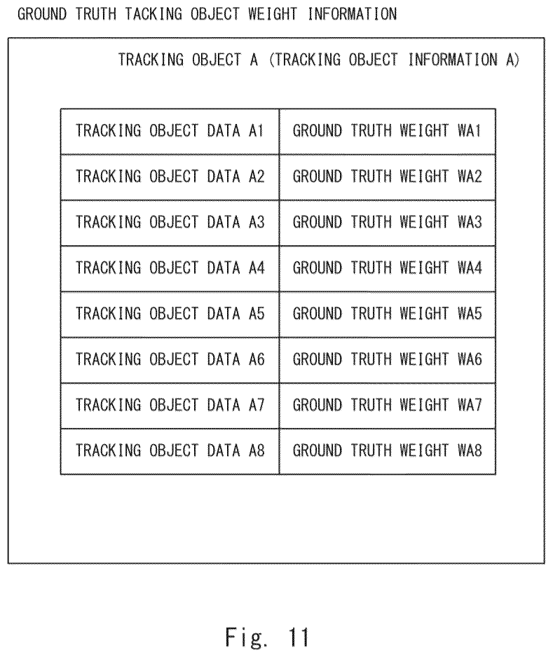

FIG. 11 is a view illustrating ground truth tracking object weight information according to the first example embodiment. FIG. 11 illustrates ground truth tracking object weight information regarding the tracking object information A (tracking object A) illustrated in FIG. 7 and the like. The ground truth tracking object weight information illustrated in FIG. 11 includes tracking object data A1 to A8 and ground truth weights WA1 to WA8 corresponding thereto. The ground truth tracking object weight information storage unit 130 stores the ground truth tracking object weight information as illustrated in FIG. 11 for each of the plurality of pieces of tracking object information (for example, the tracking object information A, the tracking object information B, and the tracking object information C).

Here, the processing in S114 of FIG. 10 will be described with reference to FIG. 11. For each piece of tracking object data of the tracking object information A, it is assumed that a weight point is assigned as follows by repetition of the processing in S102 to S112.

The total value of the weight points assigned to the tracking object data A1 is “1”.

The total value of the weight points assigned to the tracking object data A2 is “4”.

The total value of the weight points assigned to the tracking object data A3 is “0”.

The total value of the weight points assigned to the tracking object data A4 is “0”.

The total value of the weight points assigned to the tracking object data A5 is “1”.

The total value of the weight points assigned to the tracking object data A6 is “3”.

The total value of the weight points assigned to the tracking object data A7 is “0”.

The total value of the weight points assigned to the tracking object data A8 is “1”.

In the above example, the sum of the total values of the weight points assigned to each piece of the tracking object data is 1+4+0+0+1+3+0+1=10. Therefore, the ground truth weight generation unit 120 calculates a ground truth weight WA1 regarding the tracking object data A1 as 1/10=0.1. In addition, the ground truth weight generation unit 120 calculates a ground truth weight WA2 regarding the tracking object data A2 as 4/10=0.4. In addition, the ground truth weight generation unit 120 calculates a ground truth weight WA5 regarding the tracking object data A5 as 1/10=0.1. In addition, the ground truth weight generation unit 120 calculates a ground truth weight WA6 regarding the tracking object data A6 as 3/10=0.3. In addition, the ground truth weight generation unit 120 calculates a ground truth weight WA8 regarding the tracking object data A8 as 1/10=0.1. Note that, the ground truth weight generation unit 120 calculates ground truth weights WA3, WA4, and WA7 regarding the tracking object data A3, A4, and A7, respectively, as 0/10=0. As a result, the sum of the ground truth weights WA1 to WA8 is 1.

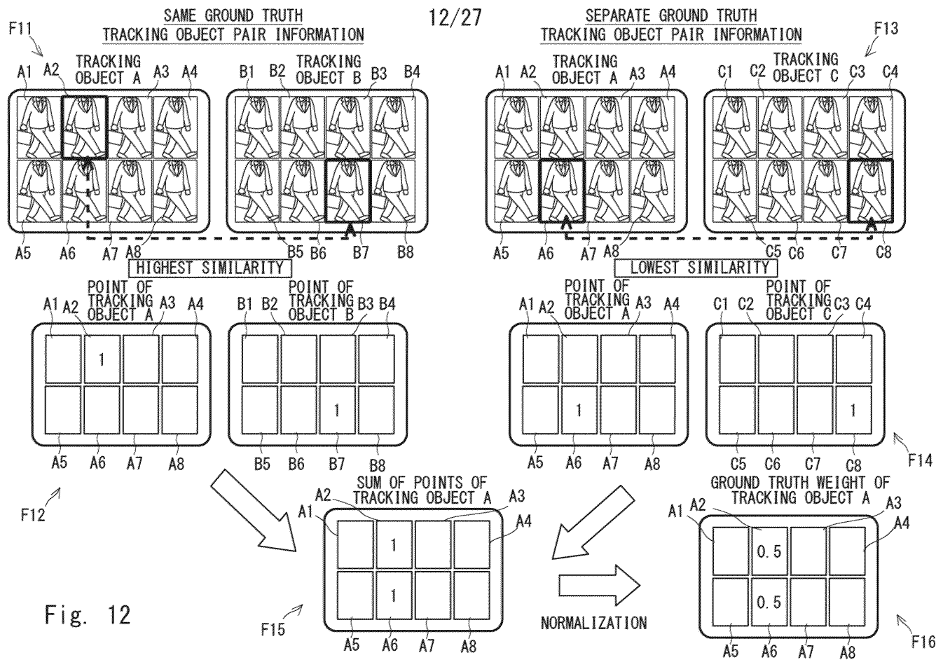

FIG. 12 is a diagram for explaining processing of the ground truth weight generation unit 120 according to the first example embodiment. FIG. 12 illustrates processing in a case where two pieces of ground truth tracking object pair information of the ground truth tracking object pair information (same ground truth tracking object pair information) illustrated in FIG. 8 and the ground truth tracking object pair information (separate ground truth tracking object pair information) illustrated in FIG. 9 are used.

In a case of the same ground truth tracking object pair information illustrated in FIG. 8, the ground truth weight generation unit 120 calculates similarity between tracking object data for all combinations of each of the tracking object data A1 to A8 and each of the tracking object data B1 to B8. Then, as indicated by an arrow F11, it is assumed that similarity between the tracking object data A2 and the tracking object data B7 is the highest. In this case, as indicated by an arrow F12, the ground truth weight generation unit 120 assigns a weight point “1” to each of the tracking object data A2 and the tracking object data B7.

In addition, in a case of the separate ground truth tracking object pair information illustrated in FIG. 9, the ground truth weight generation unit 120 calculates similarity between the tracking object data for all combinations of each of the tracking object data A1 to A8 and each of the tracking object data C1 to C8. Then, as indicated by an arrow F13, it is assumed that similarity between the tracking object data A6 and the tracking object data C8 is the highest. In this case, as indicated by an arrow F14, the ground truth weight generation unit 120 assigns a weight point “1” to each of the tracking object data A6 and the tracking object data C8.

Through the above processing, the ground truth weight generation unit 120 calculates the sum of the weight points of the tracking object data A2 as “1” and calculates the sum of the weight points of the tracking object data A6 as “1”, as indicated by an arrow F15 for the tracking object information A related to the tracking object A. Therefore, the sum of the total values of the weight points is “2”. Then, the ground truth weight generation unit 120 normalizes the sum of the weight points as indicated by an arrow F16, calculates the ground truth weight of the tracking object data A2 as “0.5” (=1/2), and calculates the ground truth weight of the tracking object data A6 as “0.5” (=1/2).

The inference model training unit 140 (FIG. 6) trains the inference model by using the ground truth tracking object weight information. The inference model training unit 140 trains an inference model that outputs a tracking object data weight corresponding to tracking object data included in the tracking object information by using data regarding the tracking object information as input data and using a ground truth weight generated for the tracking object information as ground truth data. For example, in a case where the above-described tracking object information A is used, the inference model training unit 140 trains the inference model by using data regarding the tracking object information A as input data and using the ground truth weight generated for the tracking object information A as ground truth data. That is, the inference model training unit 140 trains the inference model by using the ground truth tracking object weight information illustrated in FIG. 11.

The inference model is trained by, for example, a machine learning algorithm such as a neural network. The input data (feature) of the inference model may include, for example, feature amount information of each tracking object data included in the tracking object information. Further, the input data (feature) of the inference model may indicate, for example, a graph structure indicating a similarity relationship between the tracking object data included in the tracking object information. In this case, the inference model may be trained by using, for example, a graph neural network, a graph convolutional neural network, or the like. According to this, it is possible to train an inference model with more accuracy. The graph structure will be described later.

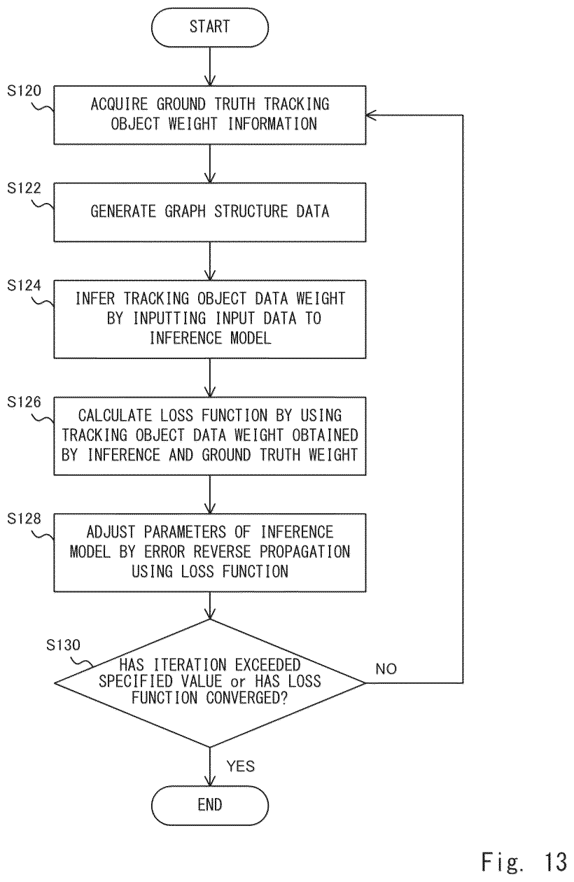

FIG. 13 is a flowchart illustrating processing of an inference model training unit 140 according to the first example embodiment. The processing of the flowchart illustrated in FIG. 13 corresponds to the processing in S14 illustrated in FIG. 2. The inference model training unit 140 acquires the ground truth tracking object weight information from the ground truth tracking object weight information storage unit 130 (step S120). As a result, the inference model training unit 140 acquires the tracking object data included in the tracking object information and a ground truth weight corresponding to each tracking object data.

The inference model training unit 140 generates data (graph structure data) indicating a graph structure of the tracking object data (step S122). Specifically, the inference model training unit 140 calculates similarity between each piece of tracking object data included in the tracking object information and all of the other tracking object data. In the example of FIG. 11, the inference model training unit 140 calculates similarity between the tracking object data A1 and each of the tracking object data A2 to A8. Similarly, the inference model training unit 140 calculates similarity between the tracking object data A2 to A8 and each of the other tracking object data. Note that, the “similarity between the tracking object data” may be cosine similarity or the like such as f_{i,j} illustrated in Expression (1). Then, the inference model training unit 140 may assign data such as a flag indicating that the similarity is equal to or greater than a predetermined threshold value to a combination in which the similarity is equal to or greater than the predetermined threshold value among the combinations of the tracking object data. Then, the inference model training unit 140 generates graph structure data indicating a combination of tracking object data with similarity equal to or greater than the threshold value.

Note that, the graph structure data may be included in the ground truth tracking object weight information in advance. In this case, the graph structure data may be generated by the ground truth weight generation unit 120 (or another constituent element).

The inference model training unit 140 inputs input data related to the tracking object data to the inference model to infer the tracking object data weight (step S124). Specifically, the inference model training unit 140 inputs, as input data, the feature amount information of the tracking object data included in the ground truth tracking object weight information (tracking object information) and the graph structure data generated in the processing in S122 to the inference model. As a result, the inference model outputs the weight (tracking object data weight) corresponding to each piece of tracking object data (tracking object information) included in the ground truth tracking object weight information. In this manner, the inference model training unit 140 infers the tracking object data weight by using the inference model.

The inference model training unit 140 calculates a loss function by using the tracking object data weight obtained by the inference and the ground truth weight (step S126). Specifically, the inference model training unit 140 calculates the loss function by using the tracking object data weight in the processing in S124 and the ground truth weight included in the ground truth tracking object weight information acquired in the processing in S120. More specifically, the inference model training unit 140 may calculate the loss function by using, for example, a least square error. That is, the inference model training unit 140 may calculate the loss function by the sum of the squares of differences between the ground truth weight and the inferred tracking object data weight for each tracking object data. Note that, the method of calculating the loss function is not limited to the method using the least square error, and any function used in machine learning may be used.

The inference model training unit 140 adjusts parameters of the inference model by error reverse propagation using the loss function (step S128). Specifically, the inference model training unit 140 adjusts the parameters of the inference model (weights of neurons of the neural network, and the like) by error reverse propagation generally used in machine learning by using the loss function calculated in S126. As a result, the inference model is trained.

The inference model training unit 140 determines whether iteration (the number of repetitions) has exceeded a specified value or whether the loss function has converged (step S130). When the iteration exceeds the specified value or the loss function converges (YES in S130), the inference model training unit 140 ends the processing. That is, the inference model training unit 140 ends the training of the inference model. Then, the inference model training unit 140 stores the trained inference model in the inference model storage unit 150.

On the other hand, when the iteration does not exceed the specified value and the loss function has not converged (NO in S130), the inference model training unit 140 continues training of the inference model. Therefore, the processing flow returns to S120. Then, the inference model training unit 140 acquires another piece of ground truth tracking object weight information (S120) and performs training processing of the inference model (S122 to S128). Then, the training processing of the inference model is repeated until the iteration exceeds the specified value or the loss function converges.

The input data designation unit 160 (FIG. 6) designates data to be used as input data. Specifically, the input data designation unit 160 may designate a component of feature amount information used in training of the inference model. The input data designation unit 160 is realized by controlling the interface unit 58. For example, the user can designate which feature is used to train the inference model by using the input data designation unit 160. For example, the user can select which component of the feature amount information is used and which component is not used by the input data designation unit 160. As a result, in a case where the user knows in advance which component of the feature amount information is valid for the inference model, the inference model can be effectively trained.

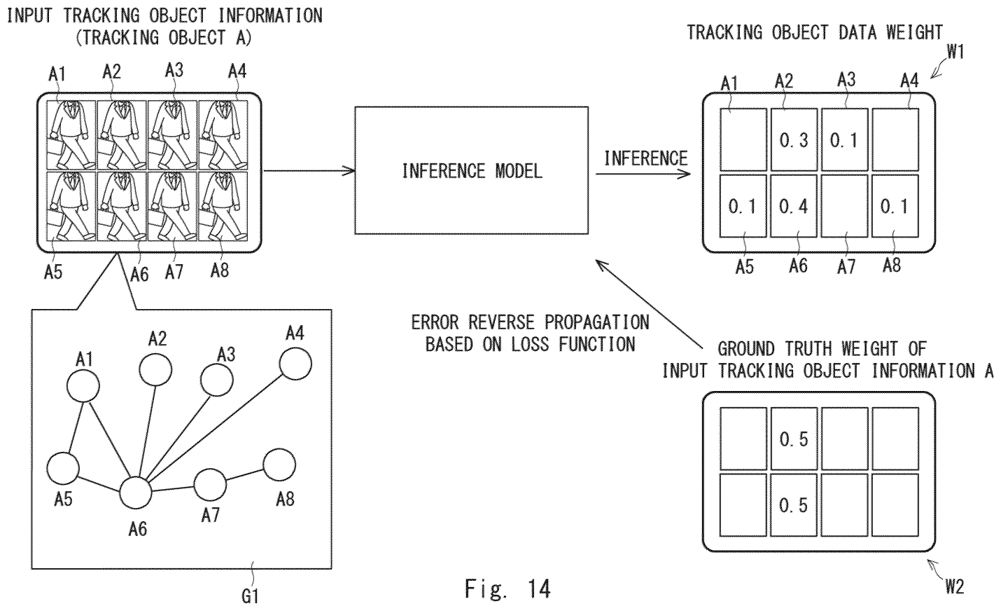

FIG. 14 is a diagram for explaining an inference model training method according to the first example embodiment. FIG. 14 illustrates a learning method using ground truth tracking object weight information regarding the tracking object information A illustrated in FIG. 11. The inference model training unit 140 acquires ground truth tracking object weight information regarding the tracking object information A (S120). Then, the inference model training unit 140 generates a graph structure G1 indicating a similarity relationship between the tracking object data A1 to A8 included in the ground truth tracking object weight information (S122). The graph structure G1 illustrated in FIG. 14 is shown so that, among combinations of the tracking object data A1 to A8, combinations with similarity equal to or greater than a threshold value are connected by lines. For example, when focus is given to the tracking object data A1, the similarity between the tracking object data A1 and the tracking object data A5, and the similarity between the tracking object data A1 and the tracking object data A6 are equal to or greater than the threshold value. Furthermore, when focus is given to the tracking object data A6, the similarity between the tracking object data A6 and each of the tracking object data A1, A2, A3, A4, A5, and A7 is equal to or greater than a threshold value.

The inference model training unit 140 inputs the feature amount information included in each of the tracking object data A1 to A8 and the graph structure data indicating the graph structure G1 to the inference model as input data (feature). As a result, the inference model training unit 140 infers the tracking object data weight corresponding to each of the tracking object data A1 to A8 as indicated by an arrow W1 (S124). In the example of FIG. 14, the tracking object data weight regarding the tracking object data A2 is “0.3”. Similarly, the tracking object data weights regarding the tracking object data A3, A5, A6, and A8 are “0.1”, “0.1”, “0,4”, and “0,1”, respectively.

The inference model training unit 140 calculates the loss function as described above by using the ground truth weight of the tracking object information A indicated by the arrow W2 and the inferred tracking object data weight indicated by the arrow W1 (S126). Then, the inference model training unit 140 adjusts the parameters of the inference model by error reverse propagation based on the calculated loss function (S128).

As described above, the learning apparatus 100 according to the first example embodiment generates the ground truth weight corresponding to the tracking object data included in the tracking object information by using the ground truth tracking object pair information. Then, the learning apparatus 100 according to the first example embodiment trains the inference model by using data regarding the tracking object information as input data and the ground truth weight generated for the tracking object information as ground truth data.

As a result, as in Expression (1), in the collation processing of the pair of tracking objects, the weight of the tracking object data can be associated with the similarity between the tracking object data included in the tracking object information regarding the first tracking object and the tracking object data included in the tracking object information regarding the second tracking object. As a result, the accuracy of the tracking object collation score can be increased. Therefore, a false acceptance rate (FAR) and a false rejection rate (FRR) can be reduced. Therefore, collation accuracy can be improved.

Further, the input data input to the inference model according to the first example embodiment is feature amount information included in each piece of tracking object data of the tracking object information and graph structure data indicating a similarity relationship between the tracking object data. With such a configuration of the input data, the input data can be data with a low load (small capacity) such as text data. Here, in a technology of training a model for inferring the tracking object feature amount by using image input data, a processing time may increase in a training stage and an inference stage of the inference model. On the other hand, in the first example embodiment, since the inference model of the tracking object weight is trained by using the input data with a low load instead of the inference model of the tracking object feature amount, the processing time can be shortened in the training stage and the inference stage of the inference model.

Furthermore, as described above, the learning apparatus 100 according to the first example embodiment calculates the similarity between each of the tracking object data included in the tracking object information of one tracking object and each of the tracking object data included in the tracking object information of the other tracking object in each of a plurality of pieces of ground truth tracking object pair information. Then, the learning apparatus 100 according to the first example embodiment generates the ground truth weight regarding the tracking object data based on the calculated similarity. With such a configuration, it is possible to generate ground truth weights more accurately.

Furthermore, as described above, the learning apparatus 100 according to the first example embodiment assigns a point (weight point) to the tracking object data based on the calculated similarity, and generates a ground truth weight regarding the tracking object data according to the number of assigned points. At that time, the learning apparatus 100 according to the first example embodiment assigns a point to the tracking object data corresponding to the highest similarity among similarities calculated by using the same ground truth tracking object pair information among a plurality of pieces of the ground truth tracking object pair information. On the other hand, the learning apparatus 100 according to the first example embodiment assigns a point to the tracking object data corresponding to the lowest similarity among similarities calculated by using the separate ground truth tracking object pair information among a plurality of pieces of the ground truth tracking object pair information. With such a configuration, it is possible to generate the ground truth weight by using both the same ground truth tracking object pair information and the separate ground truth tracking object pair information, and thus it is possible to generate the ground truth weight more accurately.

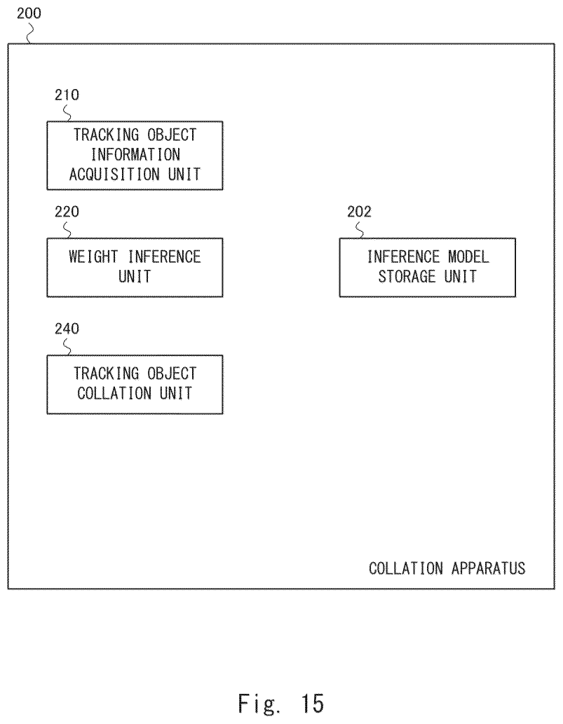

FIG. 15 is a view illustrating a configuration of the collation apparatus 200 according to the first example embodiment. The collation apparatus 200 may include the control unit 52, the storage unit 54, the communication unit 56, and the interface unit 58 illustrated in FIG. 5 as a hardware configuration. In addition, the collation apparatus 200 includes an inference model storage unit 202, a tracking object information acquisition unit 210, a weight inference unit 220, and a tracking object collation unit 240 as constituent elements. Note that, the collation apparatus 200 does not need to be configured by physically one apparatus. In this case, each of the above-described constituent elements may be realized by a plurality of physically separate apparatuses.

The inference model storage unit 202 has a function as inference model storage means. The inference model storage unit 202 stores the inference model trained by the learning apparatus 100 as described above. The tracking object information acquisition unit 210 has a function as tracking object information acquisition means. The weight inference unit 220 corresponds to the weight inference unit 22 illustrated in FIG. 3. The weight inference unit 220 has a function as weight inference means (inference means). The tracking object collation unit 240 corresponds to the tracking object collation unit 24 illustrated in FIG. 3. The tracking object collation unit 240 has a function as tracking object collation means (collation means).

The tracking object information acquisition unit 210 acquires tracking object information regarding each of a pair of tracking objects to be collated. Specifically, the tracking object information acquisition unit 210 may acquire the tracking object information generated in advance by some method from a database or the like. Alternatively, the tracking object information acquisition unit 210 may acquire the tracking object information by tracking the tracking object by using an image (video) obtained by an imaging device. In this case, as described above, the tracking object information acquisition unit 210 detects the tracking object by performing object detection processing (image processing) on the corresponding tracking object for each frame constituting the image, extracts a feature amount of the detected tracking object, and performs the object tracking processing. As a result, the tracking object information acquisition unit 210 acquires tracking object data related to the tracking object to be collated. Then, the tracking object information acquisition unit 210 acquires tracking object information including one or more pieces of tracking object data.

The weight inference unit 220 uses the trained inference model to infer the tracking object data weight corresponding to each of the tracking object data included in the tracking object information regarding the pair of tracking objects to be collated. Hereinafter, description will be given with reference to a flowchart.

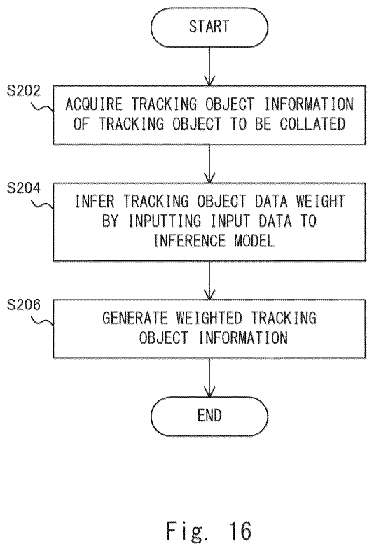

FIG. 16 is a flowchart illustrating processing of the weight inference unit 220 according to the first example embodiment. Processing of the flowchart illustrated in FIG. 16 corresponds to the processing in S22 illustrated in FIG. 4. The weight inference unit 220 acquires tracking object information of a tracking object to be collated (step S202). Specifically, for example, in a case where the tracking object A and the tracking object B are collation targets, the weight inference unit 220 acquires the tracking object information A related to the tracking object A and the tracking object information B related to the tracking object B.

The weight inference unit 220 inputs input data regarding the tracking object information acquired in S202 to the inference model to infer the tracking object data weight regarding each of the tracking object data included in the tracking object information regarding the input data (step S204). Note that, the tracking object data weight inference processing can be executed independently for each of the pair of tracking objects. That is, the weight inference unit 220 inputs input data related to the tracking object information A to infer the tracking object data weight related to each of the tracking object data A1 to A8 included in the tracking object information A. In addition, the weight inference unit 220 inputs input data related to the tracking object information B to infer the tracking object data weight related to each of the tracking object data B1 to B8 included in the tracking object information B.

For example, the weight inference unit 220 inputs feature amount information included in each tracking object data of the tracking object information to the inference model as input data. Furthermore, the weight inference unit 220 may input the above-described graph structure data to the inference model as the input data. That is, the input data may include feature amount information of each piece of tracking object data and graph structure data. Note that, the weight inference unit 220 may generate the graph structure data by the above-described method. Alternatively, the graph structure data may be generated by the tracking object information acquisition unit 210. By using the graph structure data as input data, it is possible to accurately infer the tracking object data weight.

The weight inference unit 220 generates weighted tracking object information regarding each of the pair of tracking objects to be collated (step S206). The weighted tracking object information is information in which the tracking object data included in the tracking object information acquired in S202 is associated with the tracking object data weight inferred in S204. For example, the weighted tracking object information regarding the tracking object A may have a configuration substantially similar to the ground truth tracking object weight information illustrated in FIG. 11. However, it should be noted that the weighted tracking object information regarding the tracking object A has a “tracking object data weight” obtained by inference instead of the “ground truth weight”.

The tracking object collation unit 240 collates a pair of tracking objects to be collated. Hereinafter, description will be given with reference to a flowchart.

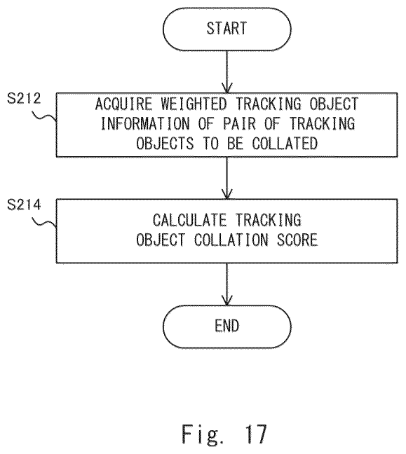

FIG. 17 is a flowchart illustrating processing in the tracking object collation unit 240 according to the first example embodiment. Processing of the flowchart illustrated in FIG. 17 corresponds to the processing in S24 illustrated in FIG. 4. The tracking object collation unit 240 acquires weighted tracking object information of a pair of tracking objects to be collated (step S212). For example, in a case where the tracking object A and the tracking object B are collation targets, the tracking object collation unit 240 acquires the weighted tracking object information of the tracking object A and the tracking object B which is generated in the processing in S206.

The tracking object collation unit 240 calculates a tracking object collation score (step S214). Specifically, the tracking object collation unit 240 calculates the tracking object collation score by using the weighted tracking object information acquired in S214. More specifically, the tracking object collation unit 240 calculates similarity between the tracking object data included in the tracking object information (weighted tracking object information) on the first tracking object of the pair of tracking objects and the tracking object data included in the tracking object information (weighted tracking object information) on the second tracking object. Then, the tracking object collation unit 240 calculates the tracking object collation score by associating the calculated similarity with the tracking object data weight related to the tracking object data corresponding to the similarity.

The tracking object collation unit 240 calculates the tracking object collation score “Score” by using, for example, Expression (1) described above. Here, it is assumed that the tracking object A and the tracking object B are collation targets. In this case, for example, the tracking object collation unit 240 calculates similarity between the tracking object data for each of all combinations of the tracking object data in the tracking object information of the tracking object A and the tracking object data in the tracking object information of the tracking object B. The tracking object collation unit 240 multiplies each similarity by two tracking object data weights corresponding to the calculated similarity. Then, the tracking object collation unit 240 calculates the sum of products obtained by multiplying each similarity by the tracking object data weight. As a result, the tracking object collation unit 240 calculates the tracking object collation score “Score” between the tracking object A and the tracking object B.

For example, the tracking object collation unit 240 calculates similarity f_{1,1} between the tracking object data A1 related to the tracking object A and the tracking object data B1 related to the tracking object B. The tracking object collation unit 240 multiplies the calculated similarity f_{1,1} by a tracking object data weight w₁^{A} related to the tracking object data A1 and a tracking object data weight w₁^{B} of the tracking object data B1. In addition, the tracking object collation unit 240 calculates similarity f_{1,2} between the tracking object data A1 related to the tracking object A and the tracking object data B2 related to the tracking object B. The tracking object collation unit 240 multiplies the calculated similarity f_{1,2} by a tracking object data weight w₁^{A} related to the tracking object data A1 and a tracking object data weight w₂^{B} of the tracking object data B2. Similarly, the tracking object collation unit 240 calculates similarity f_{1,3} to f_{1,8} between the tracking object data A1 related to the tracking object A and each of the tracking object data B3 to B8 related to the tracking object B. The tracking object collation unit 240 multiplies the calculated similarities f_{1,3} to f_{1,8} by the tracking object data weight w₁^{A} related to the tracking object data A1 and the tracking object data weights w₃^{B} to w₈^{B} of the tracking object data B3 to B8, respectively. The tracking object collation unit 240 performs similar processing for the tracking object data A2 to A8 related to the tracking object A. Then, the tracking object collation unit 240 calculates the sum of products of the obtained similarity and the tracking object data weight as a tracking object collation score.

When the tracking object collation score is equal to or greater than a predetermined threshold value, the tracking object collation unit 240 can determine that a pair of tracking objects to be collated is “the same tracking object”. On the other hand, when the tracking object collation score is less than the predetermined threshold value, the tracking object collation unit 240 can determine that a pair of tracking objects to be collated is “separate tracking objects”.

As described above, the collation apparatus 200 according to the first example embodiment uses the trained inference model to infer the tracking object data weight related to the pair of tracking objects to be collated. Then, the collation apparatus 200 according to the first example embodiment calculates the tracking object collation score regarding the pair of tracking objects to be collated by using the inferred tracking object data weight as described above. Accordingly, since the accuracy of the tracking object collation score can be improved, the accuracy of collation can be improved.

### Second Example Embodiment

Next, a second example embodiment will be described. To clarify description, in the following description and drawings, omission and simplification are made as appropriate. In each drawing, the same elements are denoted by the same reference signs, and redundant description will be omitted as necessary.

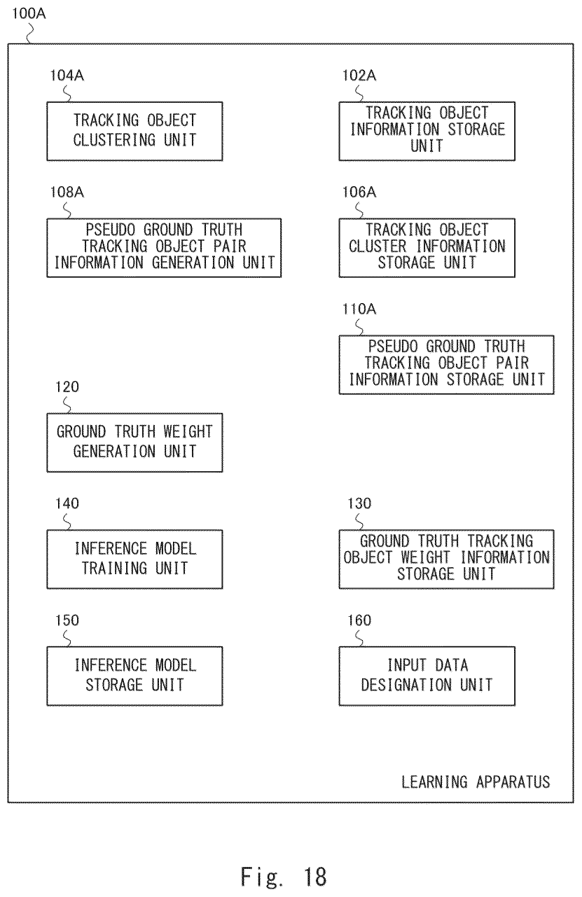

Note that, the configuration of the collation system 50 according to the second example embodiment is substantially similar to the configuration of the collation system 50 according to the first example embodiment illustrated in FIG. 5, and thus the description thereof will be omitted. Note that, the configuration of the collation apparatus 200 according to the second example embodiment is substantially similar to the configuration of the collation apparatus 200 according to the first example embodiment illustrated in FIG. 15, and thus the description thereof will be omitted. That is, the collation system 50 according to the second example embodiment includes a learning apparatus 100A (illustrated in FIG. 18) corresponding to the learning apparatus 100, and the collation apparatus 200.

In the first example embodiment, ground truth tracking object pair information is prepared and stored in advance. On the other hand, the learning apparatus 100A according to the second example embodiment is different from the first example embodiment in that pseudo ground truth tracking object pair information is generated from the tracking object information and a ground truth weight is generated by using the pseudo ground truth tracking object pair information.

FIG. 18 is a diagram illustrating a configuration of the learning apparatus 100A according to the second example embodiment. The learning apparatus 100A may include the control unit 52, the storage unit 54, the communication unit 56, and the interface unit 58 illustrated in FIG. 5 as a hardware configuration. In addition, the learning apparatus 100A includes, as constituent elements, a tracking object information storage unit 102A, a tracking object clustering unit 104A, a tracking object cluster information storage unit 106A, a pseudo ground truth tracking object pair information generation unit 108A, and a pseudo ground truth tracking object pair information storage unit 110A. As will be described later, the learning apparatus 100A generates pseudo ground truth tracking object pair information used in generation of the ground truth weight according to the configuration thereof.

In addition, the learning apparatus 100A includes, as constituent elements, a ground truth weight generation unit 120, the ground truth tracking object weight information storage unit 130, the inference model training unit 140, the inference model storage unit 150, and the input data designation unit 160 in a similar manner as in the learning apparatus 100. The functions of the ground truth weight generation unit 120, the ground truth tracking object weight information storage unit 130, the inference model training unit 140, the inference model storage unit 150, and the input data designation unit 160 are substantially similar to those according to the first example embodiment, and thus description thereof will be omitted.

Note that, the learning apparatus 100A does not need to be configured by physically one apparatus. In this case, each of the above-described constituent elements may be realized by a plurality of physically separate apparatuses. For example, the tracking object information storage unit 102A, the tracking object clustering unit 104A, the tracking object cluster information storage unit 106A, the pseudo ground truth tracking object pair information generation unit 108A, and the pseudo ground truth tracking object pair information storage unit 110A may be realized by apparatuses different from the other constituent components.

The tracking object information storage unit 102A has a function as a tracking object information storage means (information storage means). The tracking object clustering unit 104A has a function as tracking object clustering means (clustering means). The tracking object cluster information storage unit 106A has a function as tracking object cluster information storage means (information storage means). The pseudo ground truth tracking object pair information generation unit 108A has a function as pseudo ground truth tracking object pair information generation means (information generation means). The pseudo ground truth tracking object pair information storage unit 110A has a function as pseudo ground truth tracking object pair information storage means (information storage means).

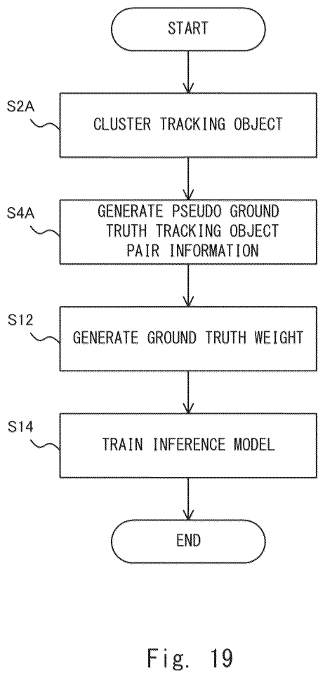

FIG. 19 is a flowchart illustrating a learning method executed by the learning apparatus 100A according to the second example embodiment. The learning apparatus 100A clusters the tracking objects (step S2A). The learning apparatus 100A generates pseudo ground truth tracking object pair information (step S4A). The learning apparatus 100A generates a ground truth weight (step S12). The learning apparatus 100A trains an inference model (step S14). Further, details of the process of S2A and S4A will be described later. In addition, since S12 and S14 are substantially similar to the processing in S12 and S14 described above, description thereof will be omitted.

The tracking object information storage unit 102A stores the tracking object information as described above in advance. The tracking object information storage unit 102A stores a plurality of pieces of tracking object information as illustrated in FIG. 7. Here, differently from the first example embodiment, the tracking object information stored in advance in the tracking object information storage unit 102A is not paired. As will be described later, the plurality of pieces of tracking object information stored in the tracking object information storage unit 102A is clustered by the processing in S2A. That is, the plurality of pieces of tracking object information stored in the tracking object information storage unit 102A is allocated to one or more clusters by the processing in S2A.

The tracking object clustering unit 104A clusters the plurality of pieces of tracking object information stored in the tracking object information storage unit 102A. Specifically, the tracking object clustering unit 104A clusters the tracking object information regarding a plurality of tracking objects considered as being identical to each other. Note that, the plurality of clustered tracking objects are not necessarily the same tracking objects in practice.

A set obtained by clustering the tracking object information regarding the plurality of tracking objects considered as being identical to each other is referred to as a “cluster (tracking object cluster)”. The tracking object cluster information storage unit 106A stores information (tracking object cluster information) regarding cluster(s) in which the tracking objects are clustered. The tracking object cluster information may indicate a cluster ID (identification information) of each cluster, and tracking object information regarding a tracking object belonging to the cluster. That is, the tracking object cluster information may indicate tracking object information regarding each tracking object and the cluster ID of the cluster to which the tracking object belongs. Note that, the tracking object cluster information may include identification information of the tracking object (tracking object information) belonging to the corresponding cluster instead of the tracking object information.

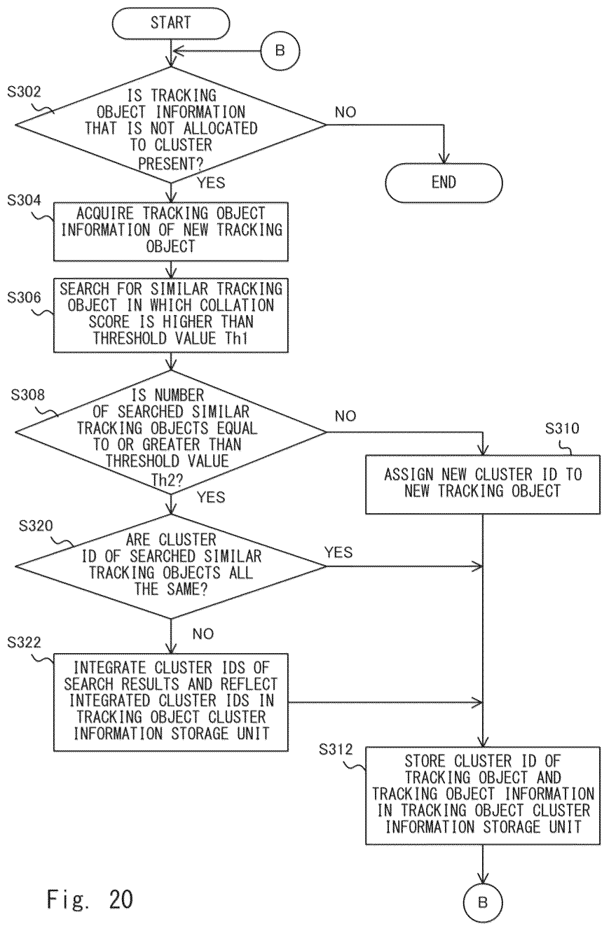

FIG. 20 is a flowchart illustrating processing of the tracking object clustering unit 104A according to the second example embodiment. Processing of the flowchart illustrated in FIG. 20 corresponds to the processing in S2A illustrated in FIG. 19.

The tracking object clustering unit 104A determines whether or not there is tracking object information that is not allocated to a cluster among a plurality of the tracking object information stored in the tracking object information storage unit 102A (step S302). The subsequent processing proceeds for each piece of the tracking object information stored in the tracking object information storage unit 102A, and in a case where there is no tracking object information that is not allocated to a cluster (NO in S302), the processing flow in FIG. 20 is terminated.

In a case where there is tracking object information that is not allocated to a cluster (YES in S302), the tracking object clustering unit 104A acquires tracking object information regarding a new tracking object from the tracking object information storage unit 102A (step S304). Here, the “new tracking object” is a tracking object that is not clustered and does not belong to any cluster.

The tracking object clustering unit 104A refers to the tracking object cluster information storage unit 106A and searches for a similar tracking object in which a collation score (tracking object collation score) with a new tracking object is a collation score higher than a predetermined threshold value Th1 (step S306). The threshold value Th1 is a threshold value representing a lower limit of the collation score at which the tracking objects are considered to be similar (substantially the same). Specifically, the tracking object clustering unit 104A calculates a collation score between all pieces of the tracking object information stored in the tracking object cluster information storage unit 106A (that is, the tracking object information of the clustered tracking object) and the tracking object information of the new tracking object. The collation score may be calculated by using, for example, Expression (2) described above. Then, the tracking object clustering unit 104A searches for a tracking object related to tracking object information whose collation score is higher than the threshold value Th1 as a similar tracking object. Note that, at a stage of processing the tracking object information acquired first, no tracking object is clustered, and the tracking object cluster information storage unit 106A does not store the tracking object information. Thus, no similar tracking object is searched.

The tracking object clustering unit 104A determines whether or not the number of searched similar tracking objects is equal to or greater than a predetermined threshold value Th2 (step S308). The threshold value Th2 is a threshold value representing the lower limit of the number of similar tracking objects belonging to the same cluster. The threshold value Th2 is an integer of 1 or greater. For example, the threshold value Th2 is 1. When the number of searched similar tracking objects is not equal to or greater than the threshold value Th2 (NO in S308), the tracking object clustering unit 104A assigns a new cluster ID to a new tracking object (step S310). That is, a new tracking object for which there are few (or no) similar tracking objects stored in the tracking object cluster information storage unit 106A is clustered into a cluster with a new cluster ID.

In this manner, the tracking object clustering unit 104A associates the new cluster ID with the tracking object information acquired in S304. As a result, the new tracking object is clustered into a cluster with the cluster ID. Then, the tracking object clustering unit 104A stores the cluster ID of the new tracking object and the corresponding tracking object information in the tracking object cluster information storage unit as the tracking object cluster information (step S312). Then, the process returns to S302.

On the other hand, when the number of searched similar tracking objects is equal to or greater than the threshold value Th2 (YES in S308), the tracking object clustering unit 104A determines whether or not cluster IDs corresponding to the searched similar tracking objects are all the same (step S320). That is, the tracking object clustering unit 104A determines whether or not the searched similar tracking object belongs to the same cluster.

When the cluster IDs of the searched similar tracking objects are all the same (YES in S320), the tracking object clustering unit 104A assigns the cluster ID to the new tracking object. As a result, the new tracking object is clustered into a cluster with the cluster ID. Then, the tracking object clustering unit 104A stores the cluster ID of the new tracking object and the corresponding tracking object information in the tracking object cluster information storage unit as the tracking object cluster information (S312).

On the other hand, when the cluster IDs of the searched similar tracking objects are not all the same (NO in S320), the tracking object clustering unit 104A integrates the cluster IDs of the search results and reflects the integrated cluster IDs in the tracking object cluster information storage unit 106A (step S322). Then, the tracking object clustering unit 104A stores the cluster ID of the new tracking object and the corresponding tracking object information in the tracking object cluster information storage unit as the tracking object cluster information (S312).

That is, in a case where the cluster IDs of the searched similar tracking object are not all the same, the tracking object clustering unit 104A assumes that the plurality of tracking objects belonging to these clusters belong to the same cluster. For example, in a case where the cluster IDs of the searched similar tracking objects are ID=#1 and #2, the tracking object clustering unit 104A assumes that the tracking objects belonging to these clusters and the new tracking object belong to the same cluster (ID=#3). That is, for example, it is assumed that a tracking object A and a tracking object B are similar to each other and belong to the same cluster (ID=#1), and a tracking object C is not similar to the tracking object A and the tracking object B and thus belongs to another cluster (ID=#2). In this case, in a case where the new tracking object D is similar to the tracking objects A, B, and C, the tracking objects A, B, C, and D belong to the same cluster (ID=#3).

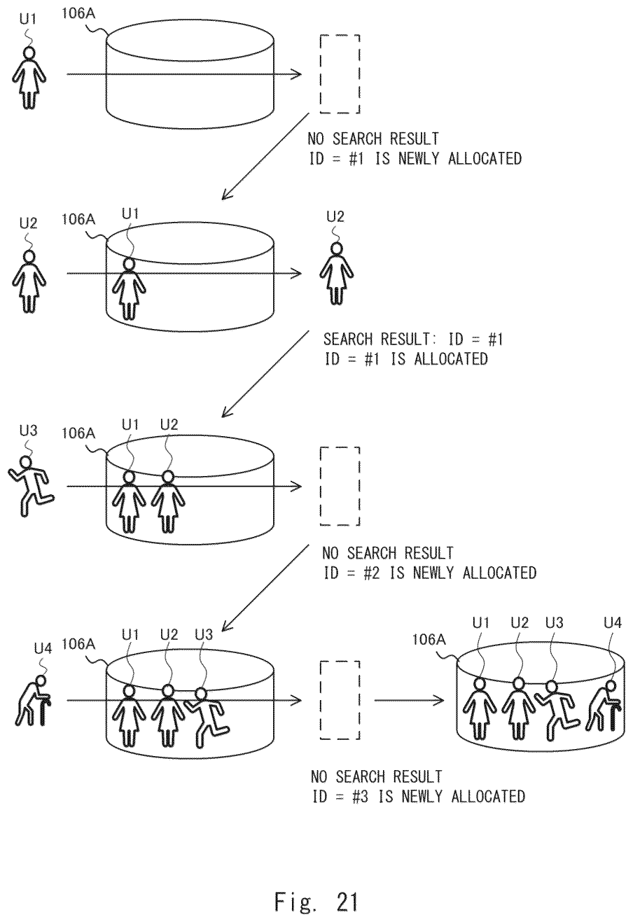

FIG. 21 is a diagram for explaining processing of the tracking object clustering unit 104A according to the second example embodiment. FIG. 21 illustrates an example of a configuration in which tracking objects U1 to U4 are clustered. First, even though the tracking object clustering unit 104A executes the processing in S306 on the tracking object U1, a similar tracking object is not searched from the tracking object cluster information storage unit 106A. This is because nothing is stored in the tracking object cluster information storage unit 106A. Therefore, the tracking object clustering unit 104A newly assigns ID=#1 to the tracking object U1 (S310). Then, the tracking object clustering unit 104A stores the tracking object information of the tracking object U1 and the cluster ID=#1 in the tracking object cluster information storage unit 106A in association with each other (S312).

Next, when the tracking object clustering unit 104A executes the processing in S306 on the tracking object U2, the tracking object U1 is searched as a similar tracking object. At this time, the number of searched similar tracking objects is equal to or greater than the threshold value Th2 (=1) (YES in S308), and the cluster IDs of the searched similar tracking objects are all the same (ID=#1) (YES in S320). Therefore, the tracking object clustering unit 104A assigns ID=#1, which is the cluster ID, to the tracking object U2. Then, the tracking object clustering unit 104A stores the tracking object information of the tracking object U2 and the cluster ID=#1 in the tracking object cluster information storage unit 106A in association with each other (S312).

Next, even though the tracking object clustering unit 104A executes the processing in S306 on the tracking object U3, since the tracking object U3 is not similar to the tracking objects U1 and U2, a similar tracking object is not searched from the tracking object cluster information storage unit 106A. Therefore, the tracking object clustering unit 104A newly assigns ID=#2 to the tracking object U3 (S310). Then, the tracking object clustering unit 104A stores the tracking object information of the tracking object U3 and the cluster ID=#2 in the tracking object cluster information storage unit 106A in association with each other (S312).

Next, even though the tracking object clustering unit 104A executes the processing in S306 on the tracking object U4, since the tracking object U4 is not similar to the tracking objects U1, U2, and U3, a similar tracking object is not searched from the tracking object cluster information storage unit 106A. Therefore, the tracking object clustering unit 104A newly assigns ID=#3 to the tracking object U4 (S310). Then, the tracking object clustering unit 104A stores the tracking object information of the tracking object U4 and the cluster ID=#3 in the tracking object cluster information storage unit 106A in association with each other (S312).

In this manner, the tracking object cluster information indicating that the tracking objects U1, U2, U3, and U4 are clustered into the above-described cluster is stored in the tracking object cluster information storage unit 106A. That is, the tracking object cluster information regarding the cluster with ID=#1 indicates that the tracking objects U1 and U2 belong to the cluster with ID=#1. In addition, the tracking object cluster information regarding the cluster of ID=#2 indicates that the tracking object U3 belongs to the cluster of ID=#2. In addition, the tracking object cluster information regarding the cluster of ID=#3 indicates that the tracking object U4 belongs to the cluster of ID=#3.

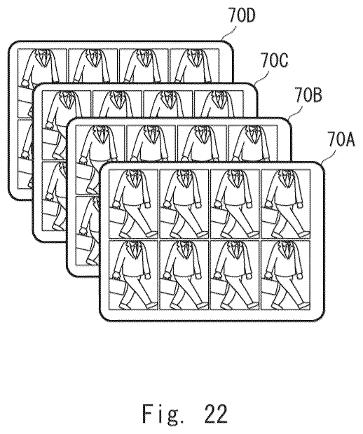

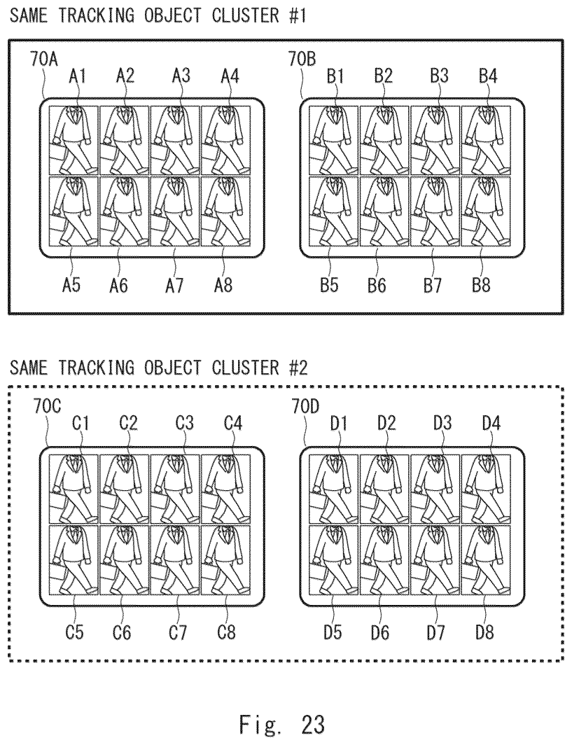

FIG. 22 is a view illustrating tracking object information stored in the tracking object information storage unit 102A according to the second example embodiment. In addition, FIG. 23 is a view illustrating a state in which the tracking object information stored in the tracking object information storage unit 102A is clustered according to the second example embodiment. In the example of FIG. 22, the tracking object information storage unit 102A stores tracking object information 70A to 70D related to the tracking objects A to D. Then, by the processing of the tracking object clustering unit 104A, the tracking object information 70A and the tracking object information 70B related to the tracking objects A and B are clustered in the cluster #1 which is a set of tracking objects regarded as being identical (similar). Similarly, the tracking object information 70C and the tracking object information 70D related to the tracking objects C and D are clustered in cluster #2 which is a set of tracking objects regarded as being identical (similar).

The tracking object cluster information storage unit 106A stores the tracking object cluster information indicating the state illustrated in FIG. 23. The tracking object cluster information may include tracking object information regarding tracking object(s) belonging to each cluster. In the example of FIG. 23, the tracking object cluster information regarding the cluster #1 may include the tracking object information 70A related to the tracking object A and the tracking object information 70B related to the tracking object B. The tracking object cluster information regarding the cluster #2 may include tracking object information 70C related to the tracking object C and tracking object information 70D related to the tracking object D.

Note that, as illustrated in FIG. 23, the tracking object information 70A includes tracking object data A1 to A8. Similarly, the tracking object information 70B includes tracking object data B1 to B8. The tracking object information 70C includes tracking object data C1 to C8. The tracking object information 70D includes tracking object data D1 to D8.

The pseudo ground truth tracking object pair information generation unit 108A (FIG. 18) generates pseudo ground truth tracking object pair information by using the tracking object cluster information stored in the tracking object cluster information storage unit 106A. The pseudo ground truth tracking object pair information is pseudo information of the ground truth tracking object pair information according to the first example embodiment. Specifically, the pseudo ground truth tracking object pair information generation unit 108A generates pseudo ground truth tracking object pair information corresponding to the same ground truth tracking object pair information or pseudo ground truth tracking object pair information corresponding to separate ground truth tracking object pair information. The description of “pseudo ground truth tracking object pair information corresponding to the same ground truth tracking object pair information” (pseudo ground truth tracking object pair information) corresponds to a set of tracking object information of tracking objects regarded as being identical. The description of “pseudo ground truth tracking object pair information corresponding to separate ground truth tracking object pair information” (pseudo separate ground truth tracking object pair information) corresponds to a set of tracking object information of tracking objects regarded as being separate. The pseudo ground truth tracking object pair information storage unit 110A stores the generated pseudo ground truth tracking object pair information. Then, the ground truth weight generation unit 120 uses the pseudo ground truth tracking object pair information as the ground truth tracking object pair information, and generates the ground truth weight by a method substantially similar to the above-described method (the method illustrated in FIG. 10).

Note that, as described above, the same ground truth tracking object pair information according to the first example embodiment is generated by using the tracking object information regarding a tracking object that is the same with certainty. On the other hand, the “pseudo ground truth tracking object pair information corresponding to the same ground truth tracking object pair information” can be generated by using the tracking object information regarding a similar tracking object (tracking object regarded as being identical) instead of the tracking object information regarding the same tracking object that is the same with certainty. In addition, as described above, the separate ground truth tracking object pair information according to the first example embodiment is generated by using the tracking object information regarding separate (different) tracking objects with certainty. In contrast to this, the “pseudo ground truth tracking object pair information corresponding to the separate ground truth tracking object pair information” can be generated by using the tracking object information regarding tracking objects which are not similar (tracking objects considered as being separate from each other) instead of the tracking object information regarding tracking objects which are separate with certainty.

In addition, the pseudo ground truth tracking object pair information generation unit 108A may generate the pseudo ground truth tracking object pair information corresponding to the same ground truth tracking object pair information by using tracking object cluster information including tracking object information regarding a predetermined number or more of tracking objects. In addition, the pseudo ground truth tracking object pair information generation unit 108A may calculate the collation score between each piece of tracking object information corresponding to first tracking object cluster information and each piece of tracking object information corresponding to second tracking object cluster information different from the first tracking object cluster information. Then, the pseudo ground truth tracking object pair information generation unit 108A may generate the pseudo ground truth tracking object pair information corresponding to separate ground truth tracking object pair information by using a set of the first tracking object cluster information and the second tracking object cluster information in which the maximum value of the collation score is equal to or less than a predetermined threshold value. Details will be described below.

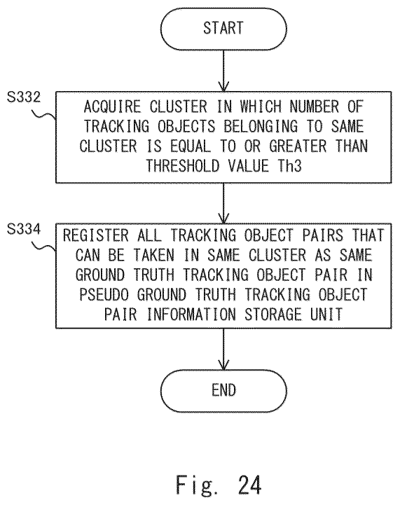

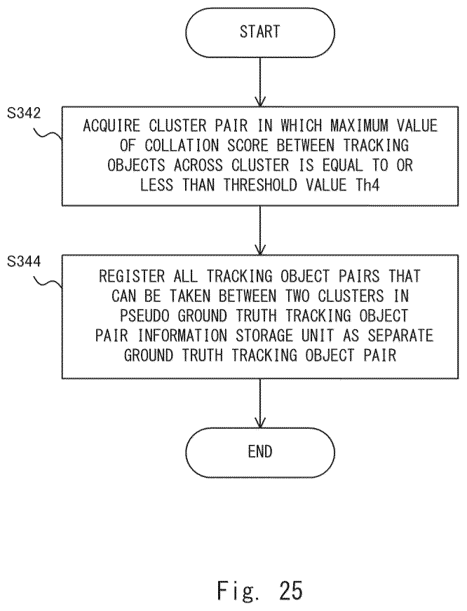

FIG. 24 and FIG. 25 are flowcharts illustrating processing of the pseudo ground truth tracking object pair information generation unit 108A according to the second example embodiment. FIG. 24 and FIG. 25 correspond to the processing in S4A shown in FIG. 19. FIG. 24 illustrates a process of generating “pseudo ground truth tracking object pair information corresponding to the same ground truth tracking object pair information”. FIG. 25 illustrates a process of generating “pseudo ground truth tracking object pair information corresponding to separate ground truth tracking object pair information”.

First, FIG. 24 will be described. The pseudo ground truth tracking object pair information generation unit 108A acquires clusters in which the number of tracking objects belonging to the same cluster is equal to or greater than a predetermined threshold value Th3 (step S332). The threshold value Th3 is a threshold value representing the lower limit of the number of tracking objects belonging to the same cluster. The threshold value Th3 is an integer of 1 or greater. Specifically, the pseudo ground truth tracking object pair information generation unit 108A determines whether or not there is a cluster in which the number of tracking objects (tracking object information) to which the same cluster ID is assigned is equal to or greater than the threshold value Th3. Then, the pseudo ground truth tracking object pair information generation unit 108A acquires the cluster.

For the acquired cluster, the pseudo ground truth tracking object pair information generation unit 108A registers all tracking object pairs that can be taken in the same cluster as the same ground truth tracking object pair in the pseudo ground truth tracking object pair information storage unit 110A (step S334). Specifically, the pseudo ground truth tracking object pair information generation unit 108A sets the tracking object pairs obtained by all combinations of the tracking objects belonging to the acquired cluster as the same ground truth tracking object pair. For example, in a case where tracking objects A, B, and C are included in the obtained cluster, the pseudo ground truth tracking object pair information generation unit 108A sets a pair of the tracking object A and the tracking object B, a pair of the tracking object A and the tracking object C, and a pair of the tracking object B and the tracking object C as the same ground truth tracking object pair. Then, the pseudo ground truth tracking object pair information generation unit 108A generates the same ground truth tracking object pair information as illustrated in FIG. 8 by using the obtained tracking object information regarding tracking objects constituting the same ground truth tracking object pair. The pseudo ground truth tracking object pair information generation unit 108A stores the generated same ground truth tracking object pair information in the pseudo ground truth tracking object pair information storage unit 110A as the pseudo ground truth tracking object pair information.

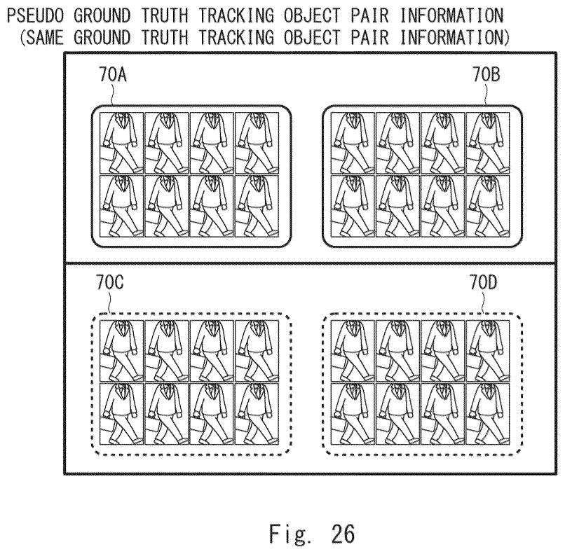

FIG. 26 is a view illustrating pseudo ground truth tracking object pair information corresponding to the same ground truth tracking object pair information according to the second example embodiment. FIG. 26 illustrates pseudo ground truth tracking object pair information corresponding to the same ground truth tracking object pair information obtained by using the cluster #1 and the cluster #2 illustrated in FIG. 23.

For example, the threshold value Th3 is set to 2. In the example of FIG. 23, both the cluster #1 and the cluster #2 include two pieces of tracking object information. Therefore, the pseudo ground truth tracking object pair information generation unit 108A acquires the cluster #1 and the cluster #2. Then, the pseudo ground truth tracking object pair information generation unit 108A sets the pair of tracking object A and tracking object B as the same ground truth tracking object pair for the cluster #1. Therefore, the pseudo ground truth tracking object pair information generation unit 108A generates the same ground truth tracking object pair information including a set of the tracking object information 70A on the tracking object A and the tracking object information 70B on the tracking object B. In addition, the pseudo ground truth tracking object pair information generation unit 108A sets the pair of tracking object C and tracking object D as the same ground truth tracking object pair for the cluster #2. Therefore, the pseudo ground truth tracking object pair information generation unit 108A generates the same ground truth tracking object pair information including a set of tracking object information 70C on the tracking object C and tracking object information 70D on the tracking object D. As a result, the pseudo ground truth tracking object pair information generation unit 108A generates the pseudo ground truth tracking object pair information indicating the pair of tracking object information 70A and tracking object information 70B and the pair of tracking object information 70C and tracking object information 70D as illustrated in FIG. 26.

Next, FIG. 25 will be described. The pseudo ground truth tracking object pair information generation unit 108A acquires a cluster pair in which the maximum value of the collation score between the tracking objects across the clusters is equal to or less than a threshold value Th4 (step S342). The threshold value Th4 is a threshold value representing an upper limit of a collation score at which a pair of tracking objects are determined as being separate tracking objects. Specifically, the pseudo ground truth tracking object pair information generation unit 108A extracts all possible combinations of clusters as a cluster pair by using the tracking object cluster information stored in the tracking object cluster information storage unit 106A.

Then, the pseudo ground truth tracking object pair information generation unit 108A calculates a collation score between the tracking objects across the clusters for each extracted cluster pair. Specifically, the pseudo ground truth tracking object pair information generation unit 108A calculates a collation score between each piece of the tracking object information included in the tracking object cluster information regarding one cluster of the cluster pair and each piece of the tracking object information included in the tracking object cluster information regarding the other cluster. That is, the pseudo ground truth tracking object pair information generation unit 108A calculates a collation score for all combinations of each piece of the tracking object information of the tracking object cluster information of one cluster and each piece of the tracking object information of the tracking object cluster information of the other cluster. The collation score may be calculated by using, for example, Expression (2) described above. Note that, the collation score is calculated for all combinations of the tracking object information stored in the tracking object information storage unit 102A by performing S306 in FIG. 20 described above. Therefore, by storing a comparison score between the tracking objects calculated in the process in S306, it becomes unnecessary to calculate the comparison score in the process in S342.

For example, it is assumed that tracking objects A1, A2, and A3 belong to one cluster A of a certain cluster pair, and tracking objects B1 and B2 belong to the other cluster B. In this case, the pseudo ground truth tracking object pair information generation unit 108A calculates a collation score between the tracking object A1 and the tracking object B1 and a collation score between the tracking object A1 and the tracking object B2. Similarly, the pseudo ground truth tracking object pair information generation unit 108A calculates a collation score between the tracking object A2 and the tracking object B1 and a collation score between the tracking object A2 and the tracking object B2. Similarly, the pseudo ground truth tracking object pair information generation unit 108A calculates a collation score between the tracking object A3 and the tracking object B1 and a collation score between the tracking object A3 and the tracking object B2.

Then, the pseudo ground truth tracking object pair information generation unit 108A determines whether or not the maximum value of the calculated collation score is equal to or less than the threshold value Th4 for each cluster pair. Here, in a case where the maximum value of the collation score is equal to or less than the threshold value Th4, this case represents that there is a high possibility that all tracking objects belonging to one cluster and all tracking objects belonging to the other cluster are separate tracking objects, the clusters constituting a cluster pair. Therefore, the pseudo ground truth tracking object pair information generation unit 108A acquires a cluster pair in which the maximum value of the collation score is equal to or less than the threshold value Th4. Then, the pseudo ground truth tracking object pair information generation unit 108A uses the acquired cluster pair to generate separate ground truth tracking object pair information in the subsequent processing (S344).

The pseudo ground truth tracking object pair information generation unit 108A registers all tracking object pairs that can be taken between the two clusters of the acquired cluster pair in the pseudo ground truth tracking object pair information storage unit 110A as separate ground truth tracking object pairs (step S344). Specifically, the pseudo ground truth tracking object pair information generation unit 108A sets tracking object pairs of all combinations of each of the tracking objects belonging to one cluster of the cluster pair and each of the tracking objects belonging to the other cluster as the separate ground truth tracking object pair. For example, it is assumed that tracking objects A1 and A2 belong to one cluster A of a certain cluster pair, and tracking objects B1 and B2 belong to the other cluster B. In this case, the pseudo ground truth tracking object pair information generation unit 108A sets a pair of the tracking object A1 and the tracking object B1, a pair of the tracking object A1 and the tracking object B2, a pair of the tracking object A2 and the tracking object B1, and a pair of the tracking object A2 and the tracking object B2 as separate ground truth tracking object pairs. Then, the pseudo ground truth tracking object pair information generation unit 108A generates the separate ground truth tracking object pair information as illustrated in FIG. 9 by using the tracking object information regarding tracking objects constituting the obtained separate ground truth tracking object pair. The pseudo ground truth tracking object pair information generation unit 108A stores the generated separate ground truth tracking object pair information in the pseudo ground truth tracking object pair information storage unit 110A as the pseudo ground truth tracking object pair information.

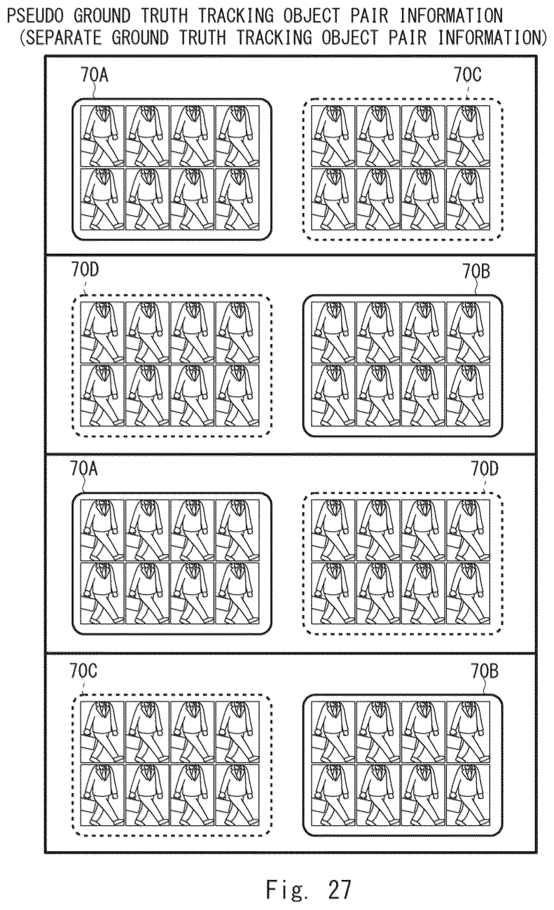

FIG. 27 is a view illustrating the pseudo ground truth tracking object pair information corresponding to the separate ground truth tracking object pair information according to the second example embodiment. FIG. 27 illustrates pseudo ground truth tracking object pair information corresponding to the separate ground truth tracking object pair information, obtained by using the cluster #1 and the cluster #2 illustrated in FIG. 23. The pseudo ground truth tracking object pair information generation unit 108A calculates a collation score between the tracking object information 70A related to the cluster #1 and each of the tracking object information 70C and 70D related to the cluster #2. In addition, the pseudo ground truth tracking object pair information generation unit 108A calculates a collation score between the tracking object information 70B related to the cluster #1 and each of the tracking object information 70C and 70D related to the cluster #2. Then, it is assumed that the calculated maximum value of the collation score is equal to or less than the threshold value Th4. Therefore, the separate ground truth tracking object pair information is generated by using the cluster pair of the cluster #1 and the cluster #2.

The pseudo ground truth tracking object pair information generation unit 108A sets a set of the tracking object A belonging to the cluster #1 and the tracking object C belonging to the cluster #2 as separate ground truth tracking object pair. Therefore, the pseudo ground truth tracking object pair information generation unit 108A generates separate ground truth tracking object pair information including the tracking object information 70A on the tracking object A and the tracking object information 70C on the tracking object C.

In addition, the pseudo ground truth tracking object pair information generation unit 108A sets a set of the tracking object A belonging to the cluster #1 and the tracking object D belonging to the cluster #2 as separate ground truth tracking object pair. Therefore, the pseudo ground truth tracking object pair information generation unit 108A generates separate ground truth tracking object pair information including the tracking object information 70A on the tracking object A and the tracking object information 70D on the tracking object D.

In addition, the pseudo ground truth tracking object pair information generation unit 108A sets a set of the tracking object B belonging to the cluster #1 and the tracking object C belonging to the cluster #2 as separate ground truth tracking object pair. Therefore, the pseudo ground truth tracking object pair information generation unit 108A generates separate ground truth tracking object pair information including the tracking object information 70B on the tracking object B and the tracking object information 70C on the tracking object C.

In addition, the pseudo ground truth tracking object pair information generation unit 108A sets a set of the tracking object B belonging to the cluster #1 and the tracking object D belonging to the cluster #2 as separate ground truth tracking object pair. Therefore, the pseudo ground truth tracking object pair information generation unit 108A generates separate ground truth tracking object pair information including the tracking object information 70B on the tracking object B and the tracking object information 70D on the tracking object D.

As a result, the pseudo ground truth tracking object pair information generation unit 108A generates pseudo ground truth tracking object pair information indicating a pair of the tracking object information 70A and the tracking object information 70C as illustrated in FIG. 27. Similarly, the pseudo ground truth tracking object pair information generation unit 108A generates pseudo ground truth tracking object pair information including a set of the tracking object information 70D and the tracking object information 70B, a set of the tracking object information 70A and the tracking object information 70D, and a set of the tracking object information 70C and the tracking object information 70B.

As described above, the learning apparatus 100A according to the second example embodiment is configured to generate the pseudo ground truth tracking object pair information by using one or more pieces of tracking object cluster information obtained by clustering tracking object information regarding a plurality of tracking objects considered as being identical to each other. That is, the learning apparatus 100A according to the second example embodiment is configured to generate pseudo ground truth tracking object pair information that is a set of tracking object information of tracking objects considered as being the same as each other or a set of tracking object information of tracking objects considered as being different from each other. Then, the learning apparatus 100A according to the second example embodiment is configured to generate the ground truth weight by using the pseudo ground truth tracking object pair information as the ground truth tracking object pair information.

As a result, it becomes unnecessary to prepare the ground truth tracking object pair information in advance as in the case of the first example embodiment. Therefore, self-trained training of the inference model can be realized. Therefore, it is possible to reduce complexity of creating training data (ground truth tracking object pair information) at the time of training the inference model. Furthermore, the tracking object information constituting the pseudo ground truth tracking object pair information is constituted by tracking object data including feature amount information. The tracking object information does not need to include image data. Therefore, the capacity of the pseudo ground truth tracking object pair information can be reduced as compared with the training data including the image data. Therefore, it is possible to perform self-trained training with low load.

Furthermore, the learning apparatus 100A according to the second example embodiment is configured to generate pseudo ground truth tracking object pair information corresponding to the same ground truth tracking object pair information by using tracking object cluster information including tracking object information regarding a predetermined number or more of tracking objects. “Tracking object cluster information including tracking object information regarding a predetermined number or more of tracking objects” corresponds to a cluster having a large size, that is, a cluster to which a plurality of tracking bodies belong. Here, when the size of the cluster is small, there is a higher possibility that the tracking objects belonging to the cluster are not the same as each other as compared with the case where the size of the cluster is large. Therefore, by using the tracking object cluster information regarding the cluster to which the predetermined number or more of tracking objects belong, it is possible to generate the pseudo ground truth tracking object pair information corresponding to the same ground truth tracking object pair information with high accuracy. That is, it is possible to generate the pseudo ground truth tracking object pair information including the pair of tracking object information regarding tracking objects which are highly likely to be the same as each other.

In addition, the learning apparatus 100A according to the second example embodiment is configured to calculate a collation score between each piece of tracking object information corresponding to first tracking object cluster information and each piece of tracking object information corresponding to second tracking object cluster information. Then, the learning apparatus 100A according to the second example embodiment is configured to generate pseudo ground truth tracking object pair information corresponding to separate ground truth tracking object pair information by using a set of the first tracking object cluster information and the second tracking object cluster information in which the maximum value of the collation score is equal to or less than a threshold value. Here, “a set of the first tracking object cluster information and the second tracking object cluster information in which a maximum value of a collation score is equal to or less than a threshold value” corresponds to a pair of clusters to which separate tracking objects are highly likely to belong. Therefore, by using the tracking object cluster information of such a cluster pair, it is possible to generate the pseudo ground truth tracking object pair information corresponding to the separate ground truth tracking object pair information with high accuracy. That is, it is possible to generate the pseudo ground truth tracking object pair information including the pair of tracking object information regarding tracking objects which are highly likely to be separate from each other.

Note that, the learning apparatus 100A according to the second example embodiment generates the pseudo ground truth tracking object pair information by using the tracking object information that does not include the tracking object data weight, but there is no limitation to such a configuration. The learning apparatus 100A may generate the pseudo ground truth tracking object pair information by using the weighted tracking object information generated by the collation apparatus 200. In this case, in a case where the weighted tracking object information is generated by the weight inference unit 220 of the collation apparatus 200 with respect to the tracking object information regarding the tracking object to be collated, the learning apparatus 100A acquires the weighted tracking object information and stores the weighted tracking object information in the tracking object information storage unit 102A. Then, the learning apparatus 100A may perform clustering of the tracking objects by using the weighted tracking object information (S2A in FIG. 19) and generate the pseudo ground truth tracking object pair information (S4A in FIG. 19).

In this case, a tracking object data weight is added to each tracking object data of the tracking object information included in the pseudo ground truth tracking object pair information. Therefore, the tracking object clustering unit 104A may use Expression (1) described above when calculating the collation score in the processing in S306 shown in FIG. 20. Similarly, the pseudo ground truth tracking object pair information generation unit 108A may use Expression (1) described above when calculating the collation score in the processing in S342 shown in FIG. 25. As a result, a more accurate comparison score is calculated as compared with the case of using Expression (2), and thus the processing in S306 and the processing in S342 can be performed with high accuracy. Therefore, there is a higher possibility that a pair of tracking objects regarding the same ground truth tracking object pair information in the pseudo ground truth tracking object pair information actually become the same tracking object. Similarly, there is a higher possibility that a pair of tracking objects regarding separate ground truth tracking object pair information in the pseudo ground truth tracking object pair information actually become separate tracking objects.

### Modification Example

Note that, the present invention is not limited to the above-described example embodiments, and can be appropriately modified without departing from the scope. For example, the order of the processes in the above-described flowchart can be changed as appropriate. Furthermore, one or more of the processes of the above-described flowchart may be omitted.

The above-described program includes a command group (or software codes) for causing a computer to perform one or more functions that have been described in the example embodiments when the program is read by the computer. The program may be stored in a non-transitory computer readable medium or a tangible storage medium. As an example and not by way of limitation, the computer readable medium or the tangible storage medium includes random-access memory (RAM), read-only memory (ROM), a flash memory, a solid-state drive (SSD) or any other memory technology, a CD-ROM, a digital versatile disk (DVD), a Blu-ray (registered trademark) disc or any other optical disk storage, a magnetic cassette, a magnetic tape, a magnetic disk storage, and any other magnetic storage device. The program may be transmitted on a transitory computer readable medium or a communication medium. As an example and not by way of limitation, the transitory computer readable medium or the communication medium includes electrical, optical, acoustic, or other forms of propagated signals.

Heretofore, although the invention of the present application has been described with reference to the example embodiments, the invention of the present application is not limited to the above description. Various modifications that can be understood by those skilled in the art can be made to the configuration and details of the invention of the present application within the scope of the invention.

Some or all of the above-described example embodiments can be described as in the following Supplementary Notes, but are not limited to the following Supplementary Notes.

### Supplementary Note 1

A learning apparatus including:
ground truth weight generation means for generating, for each piece of tracking object data of tracking object information including at least feature amount information indicating a feature of a tracking object that is an object to be tracked and including one or more pieces of tracking object data obtained by tracking the tracking object with a video, a ground truth weight corresponding to ground truth data of a tracking object data weight regarding a degree of importance indicating how well the tracking object data represents the feature of the corresponding tracking object in the tracking object information by using ground truth tracking object pair information that is a set of the tracking object information of the same tracking object or a set of the tracking object information of separate tracking objects; and
inference model training means for training, by machine learning, an inference model configured to output a tracking object data weight corresponding to tracking object data included in the tracking object information by using data regarding the tracking object information as input data and using the ground truth weight generated for the tracking object information as ground truth data,
wherein the ground truth weight generation means generates the tracking object data weight to be used in association with similarity between tracking object data included in the tracking object information regarding a first tracking object of a pair of tracking objects and tracking object data included in the tracking object information regarding a second tracking object when calculating a tracking object collation score that is a collation score of the pair of tracking objects in collation processing of the pair of tracking objects.

### Supplementary Note 2

The learning apparatus according to Supplementary Note 1, wherein the ground truth weight generation means generates a ground truth weight regarding the tracking object data based on similarity between each piece of the tracking object data included in the tracking object information of one tracking object and each piece of the tracking object data included in the tracking object information of the other tracking object in each of a plurality of pieces of the ground truth tracking object pair information.

### Supplementary Note 3

The learning apparatus according to Supplementary Note 2, wherein the ground truth weight generation means assigns a point to the tracking object data based on the calculated similarity, and generates a ground truth weight regarding the tracking object data in correspondence with the number of assigned points.

### Supplementary Note 4

The learning apparatus according to Supplementary Note 3, wherein the ground truth weight generation means assigns a point to the tracking object data corresponding to the highest similarity among similarities calculated by using the set of tracking object information of the same tracking object among the plurality of pieces of ground truth tracking object pair information.

### Supplementary Note 5

The learning apparatus according to Supplementary Note 3 or 4, wherein the ground truth weight generation means assigns a point to the tracking object data corresponding to the lowest similarity among similarities calculated by using the set of the tracking object information of separate tracking objects among the plurality of pieces of ground truth tracking object pair information.

### Supplementary Note 6

The learning apparatus according to any one of Supplementary Notes 1 to 5, further including pseudo ground truth tracking object pair information generation means for generating pseudo ground truth tracking object pair information that is a set of the tracking object information of tracking objects considered as being identical to each other or a set of the tracking object information of tracking objects considered as being separate from each other by using one or more pieces of tracking object cluster information obtained by clustering the tracking object information regarding a plurality of tracking objects considered as being identical to each other,
wherein the ground truth weight generation means generates the ground truth weight by using the pseudo ground truth tracking object pair information as the ground truth tracking object pair information.

### Supplementary Note 7

The learning apparatus according to Supplementary Note 6, wherein the pseudo ground truth tracking object pair information generation means generates the pseudo ground truth tracking object pair information that is a set of the tracking object information of tracking objects considered as being identical to each other by using the tracking object cluster information including the tracking object information regarding a predetermined number or more of tracking objects.

### Supplementary Note 8

The learning apparatus according to Supplementary Note 6 or 7, wherein the pseudo ground truth tracking object pair information generation means generates pseudo ground truth tracking object pair information that is a set of the tracking object information of tracking objects considered as being separate from each other by using a set of first tracking object cluster information and second tracking object cluster information such that a maximum value of a collation score calculated between each piece of the tracking object information corresponding to the first tracking object cluster information and each piece of the tracking object information included in the second tracking object cluster information different from the first tracking object cluster information is equal to or less than a predetermined threshold value.

### Supplementary Note 9

The learning apparatus according to any one of Supplementary Notes 1 to 8, further including input data designation means for designating an element of the input data input to the inference model.

### Supplementary Note 10

The learning apparatus according to any one of Supplementary Notes 1 to 9, wherein the inference model training means trains the inference model by using at least graph structure data indicating a similarity relationship between a plurality of pieces of the tracking object data included in the tracking object information as input data.

### Supplementary Note 11

A collation apparatus including:
weight inference means for inferring a tracking object data weight corresponding to each piece of tracking object data included in tracking object information of each of a pair of tracking objects to be collated by using an inference model trained in advance by machine learning, the inference model being trained to output the tracking object data weight corresponding to tracking object data included in the tracking object information regarding input data by using, as the input data, data regarding tracking object information including at least feature amount information indicating a feature of the tracking object that is an object to be tracked and including one or more pieces of tracking object data obtained by tracking the tracking object with a video and by using a ground truth weight, as ground truth data, corresponding to ground truth data of a tracking object data weight regarding a degree of importance indicating how well the tracking object data indicates a feature of the corresponding tracking object in the tracking object information; and
tracking object collation means for performing collation processing of the pair of tracking objects by calculating a tracking object collation score that is a collation score of the pair of tracking objects by associating similarity between tracking object data included in the tracking object information regarding a first tracking object of the pair of tracking objects and tracking object data included in the tracking object information regarding a second tracking object with the inferred tracking object data weight.

### Supplementary Note 12

The collation apparatus according to Supplementary Note 11, wherein the weight inference means uses at least graph structure data indicating a similarity relationship between a plurality of pieces of the tracking object data included in the tracking object information as the input data to infer the tracking object data weight by using the inference model.

### Supplementary Note 13

A learning method including:
generating, for each piece of tracking object data of tracking object information including at least feature amount information indicating a feature of a tracking object that is an object to be tracked and including one or more pieces of tracking object data obtained by tracking the tracking object with a video, a ground truth weight corresponding to ground truth data of a tracking object data weight regarding a degree of importance indicating how well the tracking object data represents the feature of the corresponding tracking object in the tracking object information by using ground truth tracking object pair information that is a set of the tracking object information of the same tracking object or a set of the tracking object information of separate tracking objects; and
training, by machine learning, an inference model configured to output a tracking object data weight corresponding to tracking object data included in the tracking object information by using data regarding the tracking object information as input data and using the ground truth weight generated for the tracking object information as ground truth data,
wherein the tracking object data weight is used in association with similarity between tracking object data included in tracking object information regarding a first tracking object of a pair of tracking objects and tracking object data included in tracking object information regarding a second tracking object when calculating a tracking object collation score that is a collation score of the pair of tracking objects in collation processing of the pair of tracking objects.

### Supplementary Note 14

The learning method according to Supplementary Note 13, wherein a ground truth weight regarding the tracking object data is generated based on similarity between each piece of the tracking object data included in the tracking object information of one tracking object and each piece of the tracking object data included in the tracking object information of the other tracking object in each of a plurality of pieces of the ground truth tracking object pair information.

### Supplementary Note 15

The learning method according to Supplementary Note 14, wherein a point is assigned to the tracking object data based on the calculated similarity, and a ground truth weight regarding the tracking object data is generated in correspondence with the number of assigned points.

### Supplementary Note 16

The learning method according to Supplementary Note 15, wherein a point is assigned to the tracking object data corresponding to the highest similarity among similarities calculated by using the set of tracking object information of the same tracking object among the plurality of pieces of ground truth tracking object pair information.

### Supplementary Note 17

The learning method according to Supplementary Note 15 or 16, wherein a point is assigned to the tracking object data corresponding to the lowest similarity among similarities calculated by using the set of tracking object information of the separate tracking objects among the plurality of pieces of ground truth tracking object pair information.

### Supplementary Note 18

The learning method according to any one of Supplementary Notes 13 to 17, further including:
generating pseudo ground truth tracking object pair information that is a set of the tracking object information of tracking objects considered as being identical to each other or a set of the tracking object information of tracking objects considered as being separate from each other by using one or more pieces of tracking object cluster information obtained by clustering the tracking object information regarding a plurality of tracking objects considered as being identical to each other, and
generating the ground truth weight by using the pseudo ground truth tracking object pair information as the ground truth tracking object pair information.

### Supplementary Note 19

The learning method according to Supplementary Note 18, wherein the pseudo ground truth tracking object pair information that is a set of the tracking object information of tracking objects considered as being identical to each other is generated by using the tracking object cluster information including the tracking object information regarding a predetermined number or more of tracking objects.

### Supplementary Note 20

The learning method according to Supplementary Note 18 or 19, wherein the pseudo ground truth tracking object pair information that is a set of the tracking object information of tracking objects considered as being separate from each other is generated by using a set of first tracking object cluster information and second tracking object cluster information so that a maximum value of a collation score calculated between each piece of the tracking object information corresponding to the first tracking object cluster information and each piece of the tracking object information included in the second tracking object cluster information different from the first tracking object cluster information is equal to or less than a predetermined threshold value.

### Supplementary Note 21

The learning method according to any one of Supplementary Notes 13 to 20, further including designating an element of the input data input to the inference model.

### Supplementary Note 22

The learning method according to any one of Supplementary Notes 13 to 21, wherein the inference model is trained by using at least graph structure data indicating a similarity relationship between a plurality of pieces of the tracking object data included in the tracking object information as input data.

### Supplementary Note 23

A collation method including:
inferring a tracking object data weight corresponding to each piece of tracking object data included in tracking object information of each of a pair of tracking objects to be collated by using an inference model trained in advance by machine learning, the inference model being trained to output the tracking object data weight corresponding to tracking object data included in the tracking object information regarding input data by using, as the input data, data regarding tracking object information including at least feature amount information indicating a feature of the tracking object that is an object to be tracked and including one or more pieces of tracking object data obtained by tracking the tracking object with a video and by using a ground truth weight, as ground truth data, corresponding to ground truth data of a tracking object data weight regarding a degree of importance indicating how well the tracking object data indicates a feature of the corresponding tracking object in the tracking object information; and
performing collation processing of the pair of tracking objects by calculating a tracking object collation score that is a collation score of the pair of tracking objects by associating similarity between tracking object data included in the tracking object information regarding a first tracking object of the pair of tracking objects and tracking object data included in the tracking object information regarding a second tracking object with the inferred tracking object data weight.

### Supplementary Note 24

The collation method according to Supplementary Note 23, wherein at least graph structure data indicating a similarity relationship between a plurality of pieces of the tracking object data included in the tracking object information is used as the input data to infer the tracking object data weight by using the inference model.

### Supplementary Note 25

A non-transitory computer readable medium storing a program for causing a computer to execute the learning method according to any one of Supplementary Notes 13 to 22.

### Supplementary Note 26

A non-transitory computer readable medium storing a program for causing a computer to execute the collation method according to Supplementary Note 23 or 24.

### REFERENCE SIGNS LIST

10 LEARNING APPARATUS
12 GROUND TRUTH WEIGHT GENERATION UNIT
14 INFERENCE MODEL TRAINING UNIT
20 COLLATION APPARATUS
22 WEIGHT INFERENCE UNIT
24 TRACKING OBJECT COLLATION UNIT
50 COLLATION SYSTEM
100, 100A LEARNING APPARATUS
102A TRACKING OBJECT INFORMATION STORAGE UNIT
104A TRACKING OBJECT CLUSTERING UNIT
106A TRACKING OBJECT CLUSTER INFORMATION STORAGE UNIT
108A PSEUDO GROUND TRUTH TRACKING OBJECT PAIR INFORMATION GENERATION UNIT
110 GROUND TRUTH TRACKING OBJECT PAIR INFORMATION STORAGE UNIT
110A PSEUDO GROUND TRUTH TRACKING OBJECT PAIR INFORMATION STORAGE UNIT
120 GROUND TRUTH WEIGHT GENERATION UNIT
130 GROUND TRUTH TRACKING OBJECT WEIGHT INFORMATION STORAGE UNIT
140 INFERENCE MODEL TRAINING UNIT
150 INFERENCE MODEL STORAGE UNIT
160 INPUT DATA DESIGNATION UNIT
200 COLLATION APPARATUS
202 INFERENCE MODEL STORAGE UNIT
210 TRACKING OBJECT INFORMATION ACQUISITION UNIT
220 WEIGHT INFERENCE UNIT
240 TRACKING OBJECT COLLATION UNIT

What is claimed is:

1. A learning apparatus comprising:
at least one memory configured to store instructions; and
at least one processor configured to execute the instructions to:
generate, for each piece of tracking object data of tracking object information including at least feature amount information indicating a feature of a tracking object that is an object to be tracked and including one or more pieces of tracking object data obtained by tracking the tracking object with a video, a ground truth weight corresponding to ground truth data of a tracking object data weight regarding a degree of importance indicating how well the tracking object data represents the feature of the corresponding tracking object in the tracking object information by using ground truth tracking object pair information that is a set of the tracking object information of the same tracking object or a set of the tracking object information of separate tracking objects;
train, by machine learning, an inference model configured to output a tracking object data weight corresponding to tracking object data included in the tracking object information by using data regarding the tracking object information as input data and using the ground truth weight generated for the tracking object information as ground truth data; and
generate the tracking object data weight to be used in association with similarity between tracking object data included in the tracking object information regarding a first tracking object of a pair of tracking objects and tracking object data included in the tracking object information regarding a second tracking object when calculating a tracking object collation score that is a collation score of the pair of tracking objects in collation processing of the pair of tracking objects.

2. The learning apparatus according to claim 1, wherein the at least one processor is further configured to execute the instructions to generate a ground truth weight regarding the tracking object data based on similarity between each piece of the tracking object data included in the tracking object information of one tracking object and each piece of the tracking object data included in the tracking object information of the other tracking object in each of a plurality of pieces of the ground truth tracking object pair information.

3. The learning apparatus according to claim 2, wherein the at least one processor is further configured to execute the instructions to assign a point to the tracking object data based on the calculated similarity, and generate a ground truth weight regarding the tracking object data in correspondence with a number of assigned points.

4. The learning apparatus according to claim 3, wherein the at least one processor is further configured to execute the instructions to assign a point to the tracking object data corresponding to highest similarity among similarities calculated by using the set of tracking object information of same tracking object among the plurality of pieces of ground truth tracking object pair information.

5. The learning apparatus according to claim 3, wherein the at least one processor is further configured to execute the instructions to assign a point to the tracking object data corresponding to lowest similarity among similarities calculated by using the set of the tracking object information of separate tracking objects among the plurality of pieces of ground truth tracking object pair information.

6. The learning apparatus according to claim 1, wherein the at least one processor is further configured to execute the instructions to generate pseudo ground truth tracking object pair information that is a set of the tracking object information of tracking objects considered as being identical to each other or a set of the tracking object information of tracking objects considered as being separate from each other by using one or more pieces of tracking object cluster information obtained by clustering the tracking object information regarding a plurality of tracking objects considered as being identical to each other, and
generate the ground truth weight by using the pseudo ground truth tracking object pair information as the ground truth tracking object pair information.

7. The learning apparatus according to claim 6, wherein the at least one processor is further configured to execute the instructions to generate the pseudo ground truth tracking object pair information that is a set of the tracking object information of tracking objects considered as being identical to each other by using the tracking object cluster information including the tracking object information regarding a predetermined number or more of tracking objects.

8. The learning apparatus according to claim 6, wherein the at least one processor is further configured to execute the instructions to generate pseudo ground truth tracking object pair information that is a set of the tracking object information of tracking objects considered as being separate from each other by using a set of first tracking object cluster information and second tracking object cluster information different from the first tracking object cluster information such that a maximum value of a collation score calculated between each piece of the tracking object information corresponding to the first tracking object cluster information and each piece of the tracking object information included in the second tracking object cluster information is equal to or less than a predetermined threshold value.

9. The learning apparatus according to claim 1, wherein the at least one processor is further configured to execute the instructions to designate an element of the input data input to the inference model.

10. The learning apparatus according to claim 1, wherein the at least one processor is further configured to execute the instructions to train the inference model by using at least graph structure data indicating a similarity relationship between a plurality of pieces of the tracking object data included in the tracking object information as input data.

11. A collation apparatus comprising:
at least one memory configured to store instructions; and
at least one processor configured to execute the instructions to:
infer a tracking object data weight corresponding to each piece of tracking object data included in tracking object information of each of a pair of tracking objects to be collated by using an inference model trained in advance by machine learning, the inference model being trained to output the tracking object data weight corresponding to tracking object data included in the tracking object information regarding input data by using, as the input data, data regarding tracking object information including at least feature amount information indicating a feature of the tracking object that is an object to be tracked and including one or more pieces of tracking object data obtained by tracking the tracking object with a video and by using a ground truth weight, as ground truth data, corresponding to ground truth data of a tracking object data weight regarding a degree of importance indicating how well the tracking object data indicates a feature of the corresponding tracking object in the tracking object information; and
perform collation processing of the pair of tracking objects by calculating a tracking object collation score that is a collation score of the pair of tracking objects by associating similarity between tracking object data included in the tracking object information regarding a first tracking object of the pair of tracking objects and tracking object data included in the tracking object information regarding a second tracking object with the inferred tracking object data weight.

12. The collation apparatus according to claim 11, wherein the at least one processor is further configured to execute the instructions to use at least graph structure data indicating a similarity relationship between a plurality of pieces of the tracking object data included in the tracking object information as the input data to infer the tracking object data weight by using the inference model.

13. A learning method comprising:
generating, for each piece of tracking object data of tracking object information including at least feature amount information indicating a feature of a tracking object that is an object to be tracked and including one or more pieces of tracking object data obtained by tracking the tracking object with a video, a ground truth weight corresponding to ground truth data of a tracking object data weight regarding a degree of importance indicating how well the tracking object data represents the feature of the corresponding tracking object in the tracking object information by using ground truth tracking object pair information that is a set of the tracking object information of the same tracking object or a set of the tracking object information of separate tracking objects; and
training, by machine learning, an inference model configured to output a tracking object data weight corresponding to tracking object data included in the tracking object information by using data regarding the tracking object information as input data and using the ground truth weight generated for the tracking object information as ground truth data,
wherein the tracking object data weight is used in association with similarity between tracking object data included in the tracking object information regarding a first tracking object of a pair of tracking objects and tracking object data included in the tracking object information regarding a second tracking object when calculating a tracking object collation score that is a collation score of the pair of tracking objects in collation processing of the pair of tracking objects.

14. The learning method according to claim 13, wherein a ground truth weight regarding the tracking object data is generated based on similarity between each piece of the tracking object data included in the tracking object information of one tracking object and each piece of the tracking object data included in the tracking object information of the other tracking object in each of a plurality of pieces of the ground truth tracking object pair information.

15. The learning method according to claim 14, wherein a point is assigned to the tracking object data based on the calculated similarity, and a ground truth weight regarding the tracking object data is generated in correspondence with a number of assigned points.

16. The learning method according to claim 15, wherein a point is assigned to the tracking object data corresponding to highest similarity among similarities calculated by using the set of tracking object information of same tracking object among the plurality of pieces of ground truth tracking object pair information.

17. The learning method according to claim 15, wherein a point is assigned to the tracking object data corresponding to lowest similarity among similarities calculated by using the set of tracking object information of the separate tracking objects among the plurality of pieces of ground truth tracking object pair information.

18. The learning method according to claim 13, further comprising:
generating pseudo ground truth tracking object pair information that is a set of the tracking object information of tracking objects considered as being identical to each other or a set of the tracking object information of tracking objects considered as being separate from each other by using one or more pieces of tracking object cluster information obtained by clustering the tracking object information regarding a plurality of tracking objects considered as being identical to each other; and
generating the ground truth weight by using the pseudo ground truth tracking object pair information as the ground truth tracking object pair information.

19. The learning method according to claim 18, wherein the pseudo ground truth tracking object pair information that is a set of the tracking object information of tracking objects considered as being identical to each other is generated by using the tracking object cluster information including the tracking object information regarding a predetermined number or more of tracking objects.

20. The learning method according to claim 18, wherein the pseudo ground truth tracking object pair information that is a set of the tracking object information of tracking objects considered as being separate from each other is generated by using a set of first tracking object cluster information and second tracking object cluster information different from the first tracking object cluster information such that a maximum value of a collation score calculated between each piece of the tracking object information corresponding to the first tracking object cluster information and each piece of the tracking object information included in the second tracking object cluster information is equal to or less than a predetermined threshold value.

21-26. (canceled)
